(19) United States
(12) Patent Application Publication
(10) Pub. No.: US 2003/0072059 A1
(43) Pub. Date: Apr. 17, 2003

(54) System and method for securing a communication channel over an optical network

(75) Inventors: Stephen A. Thomas, Marietta, GA (US); Thomas A. Berson, Palo Alto, CA (US); Deven J. Anthony, Tampa, FL (US); Guang Gong, Waterloo (CA); James O. Farmer, Lilburn, GA (US)

Correspondence Address: Steven P. Wigmore, Esq., KING & SPALDING, 45th Floor, 191 Peachtree Street, N.E., Atlanta, GA, 30303, US

(73) Assignee: Wave7 Optics, Inc., Alpharetta, GA (US)

(21) Appl. No.: 10/238,972

(22) Filed: Sep. 10, 2002

Related U.S. Application Data
(63) Continuation-in-part of application No. 09/899,410, filed on Jul. 5, 2001.
(60) Provisional application No. 60/318,447, filed on Sep. 10, 2001.
(60) Provisional application No. 60/388,497, filed on Jun. 14, 2002.

(51) Int. Cl. H04B 10/08; H04B 10/00

(52) U.S. Cl. 359/167; 359/110

(57) ABSTRACT

A system and method establishes a secure communication channel over an optical network. More specifically, the system and method can generally include securing a communications channel to prevent unauthorized access such as eavesdropping or masquerading by employing 1) an encryption scheme derived from the non-linear filtering of shift registers, 2) a method for authenticating and exchanging parameters between two parties over an unsecured data channel for deriving a shared encryption key having a property of perfect forward secrecy, and 3) employing a unique format of the messages that can transport non-secret key exchange parameters over an unsecured data channel and secure communications over a data channel.

### STATEMENT REGARDING RELATED APPLICATIONS

The present application is a continuation-in-part of non-provisional patent application entitled “System and Method for Communicating Optical Signals between a Data Service Provider and Subscribers,” filed on Jul. 5, 2001 and assigned U.S. application Ser. No. 09/899,410. The present application also claims priority to provisional patent application entitled, “Last Mile Link Security” filed on Sep. 10, 2001 and assigned U.S. Application Serial No. 60/318,447. The present application further claims priority to provisional patent application entitled, “Fiber—Deep Network Security,” filed on Jun. 14, 2002 and assigned U.S. Application Serial No. 60/388,497. The entire contents of the non-provisional patent application and the provisional patent applications mentioned above are hereby incorporated by reference.

### TECHNICAL FIELD

The present invention relates to security of video, voice, and data communications. More particularly, the present invention relates to security of such communications within an optical architecture.

### BACKGROUND OF THE INVENTION

The increasing reliance on communication networks to transmit more complex data, such as voice and video traffic, is causing a very high demand for bandwidth. To resolve this demand for bandwidth, communication networks are relying more upon optical fibers to transmit this complex data. Conventional communication architectures that employ coaxial cables are slowly being replaced with communication networks that comprise only fiber optic cables. One advantage that optical fibers in an optical network have over coaxial cables is that a much greater amount of information can be carried on an optical fiber.

Increased speeds and increased volumes of data are desirable features over conventional coaxial cables, but another important characteristic of an optical network is its security against unauthorized access to the data being transferred over the network. Two significant threats that can pose a threat to the integrity of an optical network have been referred to as masquerading and eavesdropping.

For optical networks that employ intelligent devices at subscriber locations that handle communications over an optical network, the threat of masquerading can be significant. Masquerading can occur where an attacker poses or masquerades as a legitimate subscriber in order to receive one or more services supplied over the optical network. The attacker could receive information such as data intended only for the legitimate subscriber.

Unlike masquerading where the attacker is trying to convince a network service provider that he/she is a legitimate user, eavesdropping involves listening or eavesdropping by the attacker on communications intended for other legitimate subscribers. By eavesdropping, an attacker can listen to communications destined for a legitimate subscriber While an attacker may not be able to decrypt intercepted communications immediately if the communications are encrypted, the communications can be archived or stored for later decryption when the attacker learns of the encryption key. Encryption is generally the process of modifying a set or stream of data with a second set of data known as a keystream, such that the first stream is not intelligible unless one knows the keystream and can apply it to the encrypted data, thus decrypting the encrypted data, recovering the original first data stream.

To prevent unauthorized access to services over communications networks, several conventional security measures have been developed. Authentication, using passwords or public key cryptography, can protect against masquerading attackers. Encryption provides protection against eavesdropping. These techniques are challenged by the high bandwidth and scale of networks based on fiber optics technology. For example, password-based authentication becomes difficult to manage in large networks. Common encryption algorithms cannot be implemented economically and still operate at the high data rates of fiber optic communications networks.

To address the problems often associated with conventional security measures, several high speed encryption algorithms have been developed. Many high speed encryption algorithms are commonly classified as either block ciphers or stream ciphers. Block ciphers operate on fixed size blocks of data, while stream ciphers can operate one bit at a time. As a general rule, block ciphers can be implemented more efficiently than can stream ciphers in computer software, while steam ciphers produce more efficient hardware implementations (including ASIC or FPGA-based hardware).

Because of the high data rates, software implementations are infeasible for optical networks. Stream ciphers, therefore, are preferred for such networks. A common class of stream ciphers are those based on LFSRs, or linear feedback shift registers, which are well known to those skilled in the art.

LFSRs can produce a continuously changing keystream that can be exclusive-OR'ed with the data to be encrypted. The exclusive-OR, or XOR, operation is well known to those skilled in the art: During this operation, two bits are compared. If the two bits are identical, that is, they are both a logical 1 or a logical 0, the output is 0. If they are different, the output is 1.

The resulting ciphertext can then be safely transmitted across an insecure network. The receiving party recovers the original data by XOR-ing the ciphertext with the same keystream. Attackers that do not know nor cannot guess the keystream are unable to eavesdrop on the communication.

Conventional LFSR ciphers generate a keystream from the output of a linear feedback shift register. As the name implies, the mathematical equation that describes an LFSR is a linear equation. An attacker attempting to guess a keystream may do so, in part, by attempting to solve linear equations. As those skilled in the art will appreciate, solving linear equations is in many cases easier than solving similar, but non-linear, equations. An LFSR cipher that relies on a non-linear operation to generate its output, therefore, may provide stronger security than conventional LFSR ciphers.

High speed encryption algorithms of all types face the problem of key distribution: both parties to the communication must agree on the initial key value. LFSRs, for example, use the initial key value to set the initial state of the shift register. If the communication channel between the parties is insecure (which is likely the case if the parties desire to use encryption), then keys cannot simply be transferred across this channel. Two approaches have been developed to solve this problem: key exchange protocols and public key cryptography.

An exemplary key exchange protocol is the Diffie-Hellman protocol (D-H). Two parties that wish to use D-H each generate a secret value. The parties derive non-secret values from their secret values and exchange those non-secret values across the communication channel. Each party mathematically combines his secret value with the other's non-secret value to derive a key. The mathematical operations are such that both parties will derive the same key, yet an eavesdropper that can access the non-secret values cannot calculate the same key.

Because D-H participants select new secret values for each communication session, the D-H protocol possesses a property known as “perfect forward secrecy.”If an attacker were to learn one party's secret value, knowing it and the non-secret values would allow that attacker to calculate the key and decipher the communication. However, this knowledge would be of no help to the attacker in trying to decipher previous or subsequent communication sessions.

Public key cryptography, exemplified by RSA (a cryptographic algorithm known to those skilled in the art), solves the key distribution problem another way. Public key cryptography is itself a form of encryption. Instead of a single encryption key, however, each party uses a different key value. One key value is known as the public key, while the other is known as the private key. The key values are related in such a way that data encrypted with the public key can only be decrypted with the private key. Furthermore, knowledge of the public key cannot be used to discover or guess the private key. These properties allow communicating parties to safely send each other their public keys. An eavesdropper will gain no advantage by overhearing this exchange.

To use public key cryptography for key distribution, one party sends the other its public key. The second party generates an encryption key, encrypts that encryption key with the first party's public key, and sends the result to the first party. The first party uses its private key to recover the encryption key, which may then be used for a block or stream cipher. (Note that public key cryptography itself is rarely used to encrypt communications traffic because it is much less efficient than block or stream ciphers.)

Unlike the secret values used in the D-H protocol, public and private keys are typically not changed very frequently (common key lifetimes for cable modems, as an example, are 20 years). Because a party reuses the same public and private key with each communication session, public key-based key distribution does not provide perfect forward secrecy. If an attacker discovered a party's private key, the attacker could also discover the encryption keys for all sessions with that party.

Public key cryptography does provide one significant feature not available with D-H key exchange: authentication. Because public-private key pairs have a long lifetime, they can be associated with a communicating party for a long period of time. Parties do not change their public/private key pairs frequently, nor are public/private key pairs re-used by multiple parties. These properties let communicating parties authenticate each other using public key cryptography. If one party confidently knows the public key of another, it can encrypt a random value with that public key, send it to an entity claiming to be the second party, and challenge that entity to decrypt the value. The entity can only meet that challenge if it knows the appropriate private key. So long as only the authentic second party possesses the private key, a successful decryption will authenticate the identity of the second party.

Of the two approaches to key distribution, key exchange protocols can provide perfect forward secrecy but not authentication. Public key cryptography, on the other hand, provides authentication but not perfect forward secrecy. An application that desires both perfect forward secrecy and authentication with its key distribution could use both approaches independently; however, doing so increases the computation burden and communications burden on the parties. Accordingly, there is a need in the art for a system and method to provide key distribution, authentication, and perfect forward secrecy in a manner as efficient as possible.

One exemplary and conventional “public-key” algorithm that has been developed is RSA, named after its inventors, Ron Rivest, Adi Shamir, and Leonard Adleman. Further details of the RSA algorithm as well as other public-key algorithms are discussed in a book by Bruce Schneier, Applied Cryptography, Second Edition, John Wiley and Sons, New York 1996, the contents of the entire book are hereby incorporated by reference. Algorithms are called “public-key” if the encryption key can be made public. This means that any person can use the encryption key to encrypt a message, but only a person with the corresponding decryption (private) key can decrypt the message. In these algorithms, the encryption key is often called the public key, and the decryption key is often called the private key.

Accordingly, there is a need in the art to provide a way to combine authentication with perfect forward secrecy key exchange, while minimizing the number of messages that must be exchanged in order to effect the two functions. Another need exists in the art to determine how to use a key obtained using the Diffie-Hellman key exchange protocol to generate a very long non-linear encryption stream that is not easily discovered or decrypted.

In other words, a need exists in the art for a method and system that can generate a key stream that is not derived from shift registers possessing linear relationships between feedback taps. Specifically, there is a need in the art for a method and system that generates a key stream from feedback taps in a non-linear manner. A further need exists in the art for a method and system that provides for an increase in speed at which a key stream is generated.

### SUMMARY OF THE INVENTION

The present invention is generally drawn to a system and method for establishing a secure communication channel over an optical network. More specifically, the system and method can generally include securing a communications channel to prevent unauthorized access such as eavesdropping or masquerading by employing 1) an encryption scheme derived from the non-linear filtering of shift registers, 2) a method for authenticating and exchanging parameters between two parties over an unsecured data channel for deriving a shared encryption key having a property of perfect forward secrecy, and 3) employing a unique format of the messages that transports non-secret key exchange parameters over an unsecured data channel and secure communications over a data channel.

According to one exemplary inventive aspect of the present invention, an encryption scheme derived from the non-linear filtering of shift registers can include selecting a first and a second tap to achieve one or more non-linear output properties for a particular shift register. Specifically, the output of a first tap and a second tap of each shift register can be combined and a logical “and” operation of the combined output of these two taps can be taken. The first tap and second tap can be specifically selected based upon their mathematical properties to assist in optimizing the non-linear filtering function. The resultant value of the logical “and” operation can then be combined with a least significant bit (known as the output bit) of a shift register.

Next, a logical “exclusive or” (XOR) of the combination of the resultant value and the least significant bit for each register can be taken. This XOR operation from each register can be combined with other XOR operations from other shift registers in a group of shift registers. Another XOR operation can be taken of the combined output from the group of shift registers. That is, a second XOR operation for the combined output of multiple shift registers can occur after a first XOR operation that is taken between the logical “and” value and least significant bit at each individual shift register.

Subsequently, the output from multiple or parallel groups or sets of registers can also be combined to generate a keystream. The keystream can be combined with plain text to generate ciphertext. The encryption scheme producing the cipher text can have a key size of 128 bits that determines the initial state of a plurality of shift registers. Also unlike the conventional art, the present invention can generate parallel keystreams using simple hardware to increase the speed at which the resultant keystream is produced.

To produce the new bit in each register, the present invention can employ a majority clock function. The majority clock function can work as follows: one feedback tap in each register in a group of registers can be designated as a clock tap. The output from each clock tap of a group of registers can be combined where the majority value from this output is calculated. At each clock cycle, each register can determine if its clock tap matches the majority value. If its clock tap matches the majority value, then the register can be permitted to produce a new bit. Each new bit can be produced by combining the output of the least significant bit of a register with the output of another tap in the register. A logical XOR operation can be performed on this combined output where the new bit is the result of this operation.

Prior to using any data produced from the registers of the present invention, each register can be operated for at least 1,031 clock cycles. This value of 1,031 clock cycles can comprise the first prime number greater than the value 1,024.

According to another exemplary inventive aspect of the present invention, a method for authenticating and exchanging parameters between two parties over an unsecured data channel for deriving a shared secret encryption key can provide perfect forward secrecy using a minimum amount of communications bandwidth. That is, the method for authenticating and exchanging parameters for deriving a shared encryption key can prevent unauthorized access to encrypted messages even if a party later divulges its private key. The method can employ an asymmetric encryption algorithm, such as a public-key algorithm, that functions as a carrier to transport the parameters of a symmetric algorithm such as key exchange parameters of the Diffie-Hellman protocol.

And more specifically, the method according to this exemplary aspect of the present invention can include assigning a large prime number to both parties. Next, a first party can check if a public key certificate of a second party is valid. If the public key certificate is valid, the first party can send to the second party a message comprising an encrypted non-secret key exchange value and a random number, where both the value and the random number are encrypted with the public key belonging to the second party.

The second party can decrypt the message with its private key associated with its public key to recover the non-secret value and the random number. The second party can then select its own non-secret exchange and secret key values. The second party can combine the first party's non-secret value with its secret value to generate the shared secret encryption key. The second party can send its non-secret value unencrypted, and the random number encrypted with the shared secret key.

Upon receipt of the second party's non-secret value, the first party can generate the same shared secret key as generated by the second party. The first party can then decrypt the received encrypted random number to verify that it is the same encrypted random number that was originally sent to the second party. Once this random number is verified as correct, encrypted communications can be exchanged between the first and second parties with the shared secret key.

According to another exemplary inventive aspect of the present invention, the format of the messages for exchanging the key distribution and authentication parameters can assist in providing for secure communications over a data channel. Each message can be carried in Ethernet frames. Each message can comprise a header and a payload. A portion of each header can comprise a protocol version number. Another portion of each header can identify the message type. Other portions of each header can comprise length of the message payload that may or may not include the size of the header.

Each payload can comprise a series of individual objects. Each object can have similar or the same format. First portions of each object can identify the object type as well as the length of the object data. Each object can comprise one of a status, a cryptosuite, a public key certificate, a non-secret key exchange parameter encrypted with a public key, a nonce encrypted with the public key, and a nonce encrypted with a secret key.

### BRIEF DESCRIPTION OF THE DRAWINGS

FIG. 1 is a functional block diagram illustrating some core components of an exemplary optical network architecture according to the present invention.

FIG. 2 is a functional block diagram illustrating additional aspects of an exemplary optical network architecture according to the present invention.

FIG. 3 is a functional block diagram illustrating an exemplary data service hub of the present invention.

FIG. 4 is a functional block diagram illustrating an exemplary laser transceiver node according to the present invention.

FIG. 5 is a functional block diagram illustrating an optical tap connected to a subscriber optical interface by an optical waveguide according to one exemplary embodiment of the present invention.

FIG. 6 is a functional block diagram illustrating an exemplary single shift register according to the present invention.

FIG. 7 is a functional block diagram illustrating a group of shift registers according to an exemplary embodiment of the present invention.

FIG. 8 is a functional block diagram illustrating how sets or groups of registers are combined to produce a keystream and ciphertext according to one exemplary embodiment of the present invention.

FIG. 9 is a logic flow diagram illustrating an exemplary method for generating ciphertext.

FIG. 10 is a logic flow diagram illustrating an exemplary submethod of FIG. 9 for generating non-linear filtered output bit(s) from shift registers according to one exemplary embodiment of the present invention.

FIG. 11 is a functional block diagram illustrating an exemplary number of messages and the content of these messages that are exchanged between the two parties according to an exemplary embodiment of the present invention.

FIG. 12 is a logic flow diagram illustrating steps taken by one party of the present invention where the steps are part of an exemplary method for authenticating and exchanging parameters for deriving a shared secret key according to one exemplary embodiment of the present invention.

FIG. 13 is a logic flow diagram illustrating a submethod of FIG. 12 for validating a public key certificate received from a party according to an exemplary embodiment of the present invention.

FIG. 14 is a logic flow diagram illustrating steps taken by a party that is different from the party of FIG. 12 where the steps form a part of a method for authenticating and exchanging parameters for deriving a shared secret key according to one exemplary embodiment of the present invention.

FIG. 15 is a functional block diagram illustrating the relationship between messages from the present invention and the formatting of ethernet type messages.

FIG. 16 is a functional block diagram illustrating exemplary message formats according to one exemplary embodiment of the present invention.

FIG. 17 is a table illustrating exemplary content of the message exchange between parties according to one exemplary embodiment of the present invention.

FIG. 18 is a table illustrating the various exemplary objects used by an exemplary protocol according to the present invention.

FIG. 19 is a table illustrating various exemplary values of a status object according to the present invention.

FIG. 20 is a table illustrating various exemplary values for a cryptosuite object according to the present invention.

FIG. 21 is a table illustrating exemplary messages type while as the parties that may produce these message sites according to an exemplary embodiment of the present invention.

### DETAILED DESCRIPTION OF EXEMPLARY EMBODIMENTS

Unauthorized access to a communications channel can be prevented by employing 1) an encryption scheme derived from the non-linear filtering of shift registers, 2) a method for authenticating and exchanging parameters between two parties over an unsecured data channel for deriving a shared secret key, and 3) employing a unique format of the messages that transmits non-secret key exchange parameters and encrypted data over a channel.

For the encryption scheme, the output of a first and a second tap of each shift register can be combined and a logical “and” operation of the combined output of these two taps can be taken. The first and second taps can be specifically selected based upon their mathematical properties to assist in producing the non-linear filtering function. The resultant value of the logical “and” operation can then be combined with a least significant bit (known as the output bit) of a shift register.

Next, a logical exclusive “or” of the combination of the resultant value and the least significant bit for each register can be taken. This exclusive “or” operation from each register can be combined with other exclusive “or” operations from other shift registers in a group of shift registers.

In the method for authenticating and exchanging parameters, a public key encryption algorithm can function as a carrier to transport the parameters of a key exchange protocol. By operating in this manner, the method can reduce the number of messages needed to authenticate and exchange the parameters for deriving a shared secret key compared to the number of messages used in the conventional art.

Illustrative Operating Environment for the Invention

Referring now to the drawings, in which like numerals represent like elements throughout the several Figures, aspects of the present invention and the illustrative operating environment will be described.

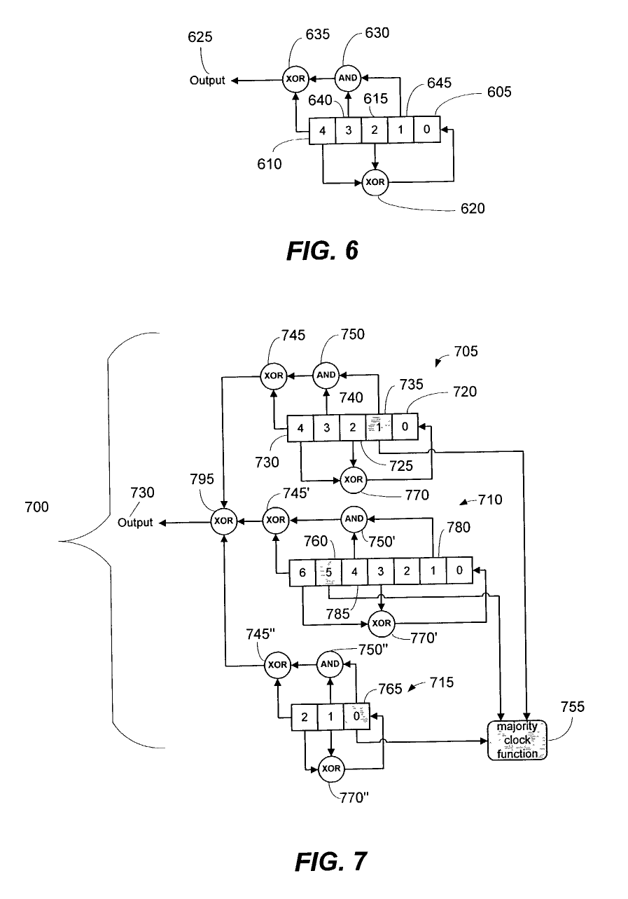

FIG. 1 is a functional block diagram illustrating an exemplary optical network architecture 100 according to the present invention. The exemplary optical network architecture 100 comprises a data service hub 110 that is connected to one or more outdoor laser transceiver nodes 120. The laser transceiver nodes 120, in turn, are connected to optical taps 130. The optical taps 130 can be connected to a plurality of subscriber optical interfaces 140. Specifically, the optical taps 130 maybe connected to subscriber optical interfaces 140 that comprise a security system 115 that will be described in further detail below with respect to FIGS. 6-21.

Between respective components of the exemplary optical network architecture 100 are optical waveguides such as optical waveguides 150, 160, 170 and 180. The optical waveguides 150-180 are illustrated by arrows with the arrowheads of the arrows illustrating exemplary directions of the data flow between respective components of the illustrative an exemplary optical network 100.

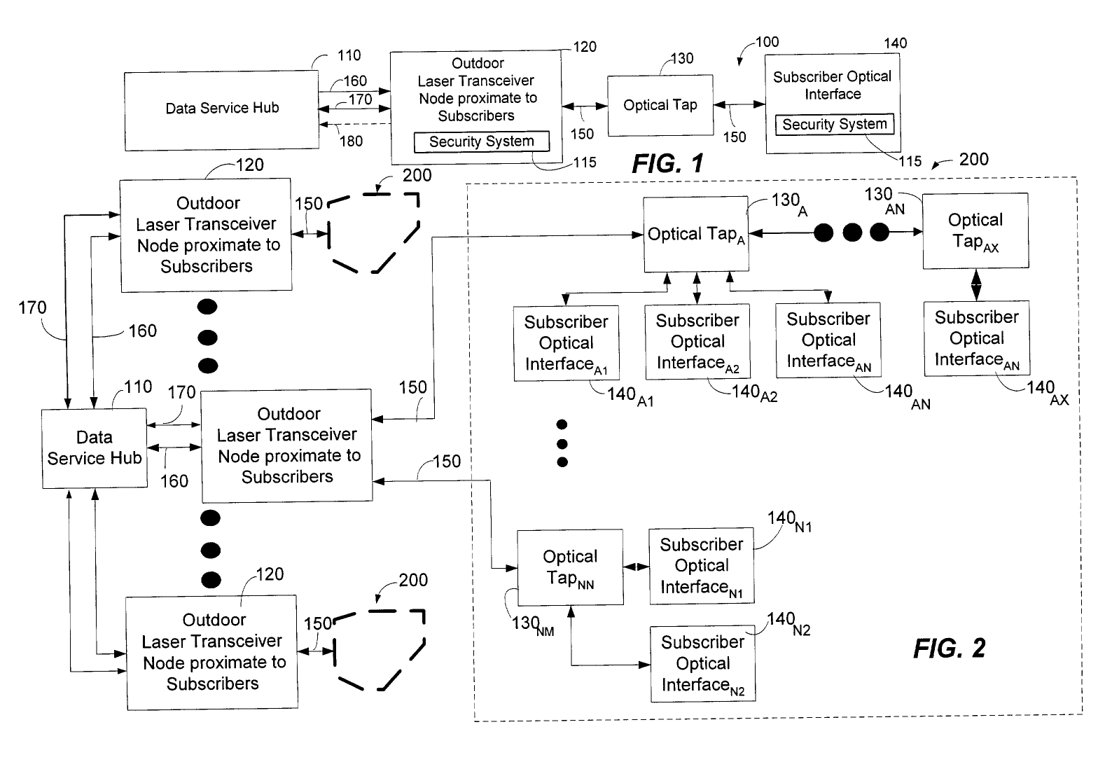

While only an individual laser transceiver nodes 120, individual optical taps 130, and individual subscriber optical interfaces 140 are illustrated in FIG. 1, as will become apparent from FIG. 2, in its corresponding description, a plurality of laser transceiver nodes 120, optical taps 130, and subscriber optical interfaces 140 can be employed without departing from the scope and spirit of the present invention. Typically, in many of the exemplary embodiments of the present invention, multiple subscriber optical interfaces 140 are connected to one or more optical taps 130.

The outdoor laser transceiver node 120 can allocate additional or reduced bandwidth based upon the demand of one or more subscribers that use the subscriber optical interfaces 140. The laser transceiver node 120 can comprise encryption registers 117, similar to those found in the subscriber optical interface 140 as will be discussed below with respect to FIGS. 6-7. The outdoor laser transceiver node 120 can be designed to withstand outdoor environmental conditions and can be designed to hang on a strand or fit in a pedestal or “hand hole.” The outdoor laser transceiver node can operate in a temperature range between minus 40 degrees Celsius to plus 60 degrees Celsius. The laser transceiver node 120 can operate in this temperature range by using passive cooling devices that do not consume power.

In one exemplary embodiment of the present invention, three trunk optical waveguides 160, 170, and 180 (that can comprise optical fibers) can conduct optical signals from the data service hub 110 to the outdoor laser transceiver node 120. It is noted that the term “optical waveguide” used in the present application can apply to optical fibers, planar light guide circuits, and fiber optic pigtails and other like optical waveguides.

A first optical waveguide 160 can carry broadcast video and other signals. The signals can be carried in a traditional cable television format wherein the broadcast signals are modulated onto carriers, which in turn, modulate an optical transmitter (not shown) in the data service hub 110. A second optical waveguide 170 can carry downstream targeted services such as data and telephone services to be delivered to one or more subscriber optical interfaces 140. In addition to carrying subscriber-specific optical signals, the second optical waveguide 170 can also propagate internet protocol broadcast packets, as is understood by those skilled in the art.

In one exemplary embodiment, a third optical waveguide 180 can transport data signals upstream from the outdoor laser transceiver node 120 to the data service hub 110. The optical signals propagated along the third optical waveguide 180 can also comprise data and telephone services received from one or more subscribers. Similar to the second optical waveguide 170, the third optical waveguide 180 can also carry IP video packets, as is understood by those skilled in the art.

The third or upstream optical waveguide 180 is illustrated with dashed lines to indicate that it is merely an option or part of one exemplary embodiment according to the present invention. In other words, the third optical waveguide 180 can be removed. In another exemplary embodiment, the second optical waveguide 170 propagates optical signals in both the upstream and downstream directions as is illustrated by the double arrows depicting the second optical waveguide 170.

In such an exemplary embodiment where the second optical waveguide 170 propagates bidirectional optical signals, only two optical waveguides 160, 170 would be needed to support the optical signals propagating between the data server's hub 110 in the outdoor laser transceiver node 120. In another exemplary embodiment (not shown), a single optical waveguide can be the only link between the data service hub 110 and the laser transceiver node 120. In such a single optical waveguide embodiment, three different wavelengths can be used for the upstream and downstream signals. Alternatively, bi-directional data could be modulated on one wavelength.

In one exemplary embodiment, the optical tap 130 can comprise an 8-way optical splitter. This means that the optical tap 130 comprising an 8-way optical splitter can divide downstream optical signals eight ways to serve eight different subscriber optical interfaces 140. In the upstream direction, the optical tap 130 can combine the optical signals received from the eight subscriber optical interfaces 140.

In another exemplary embodiment, the optical tap 130 can comprise a 4-way splitter to service four subscriber optical interfaces 140. Yet in another exemplary embodiment, the optical tap 130 can further comprise a 4-way splitter that is also a pass-through tap meaning that a portion of the optical signal received at the optical tap 130 can be extracted to serve the 4-way splitter contained therein while the remaining optical energy is propagated further downstream to another optical tap or another subscriber optical interface 140. The present invention is not limited to 4-way and 8-way optical splitters. Other optical taps having fewer or more than 4-way or 8-way splits are not beyond the scope of the present invention.

Referring now to FIG. 2, this figure is a functional block diagram illustrating an exemplary optical network architecture 100 that includes various types of subscribers who use the subscriber optical interfaces 140. Specifically, one type of a subscriber can comprise a large business subscriber or a multi dwelling or multiple business subscribers. Another type of subscriber can comprise a home or personal-use or small business subscriber. The terms “large” and “small” are defined relative to the amount of bandwidth needed or demanded by a particular subscriber.

Each optical tap 130 can comprise an optical splitter. The optical tap 130 allows multiple subscriber optical interfaces 140 to be coupled to a single optical waveguide 150 that is connected to the outdoor laser transceiver nodes 120. In one exemplary embodiment, six optical fibers 150 are designed to be connected to the outdoor laser transceiver nodes 120. For the use of optical taps 130, sixteen subscribers can be assigned to each of the six optical waveguides 150 that are connected to the outdoor laser transceiver nodes 120.

In another exemplary embodiment, twelve optical fibers 150 can be connected to the outdoor laser transceiver nodes 120 while eight subscriber optical interfaces 140 are assigned to each of the twelve optical waveguides 150. Those skilled in the art will appreciate the number of subscriber optical interfaces 140 assigned to a particular waveguide 150 that is connected between the outdoor laser transceiver nodes 120 and a subscriber optical interface 140 (by way of the optical tap 130) can be varied or changed without departing from the scope and spirit of the present invention. Further, those skilled in the art recognize that the actual number of subscriber optical interfaces 140 assigned to a particular optical waveguide is dependent upon the amount of power available on a particular optical waveguide 150.

As depicted in FIG. 2, many configurations for supplying communication services to subscribers are possible. The combinations of optical taps 130 with other optical taps 130 in addition to combinations of optical taps with various subscriber optical interfaces 140 are limitless. With the optical taps 130, concentrations of distribution optical waveguide 150 at the laser transceiver nodes 120 can be reduced. Additionally, the total amount of fiber needed to service the subscriber grouping attached to a single subscriber interface 140 can also be reduced.

With the active laser transceiver node 120 of the present invention, the distance between the laser transceiver node 120 and the data service hub 110 can comprise a range between 0 and 80 kilometers. However, the present invention is not limited to this range. Those skilled in the art will appreciate that this range can be expanded by selecting various off-the-shelf components that make up several of the devices of the present system.

Those skilled in the art will appreciate that other configurations of the optical waveguides disposed between the data service hub 110 and outdoor laser transceiver node 120 are not beyond the scope of the present invention. Because of the bi-directional capability of optical waveguides, variations in the number and directional flow of the optical waveguides disposed between the data service hub 110 and the outdoor laser transceiver node 120 can be made without departing from the scope and spirit of the present invention.

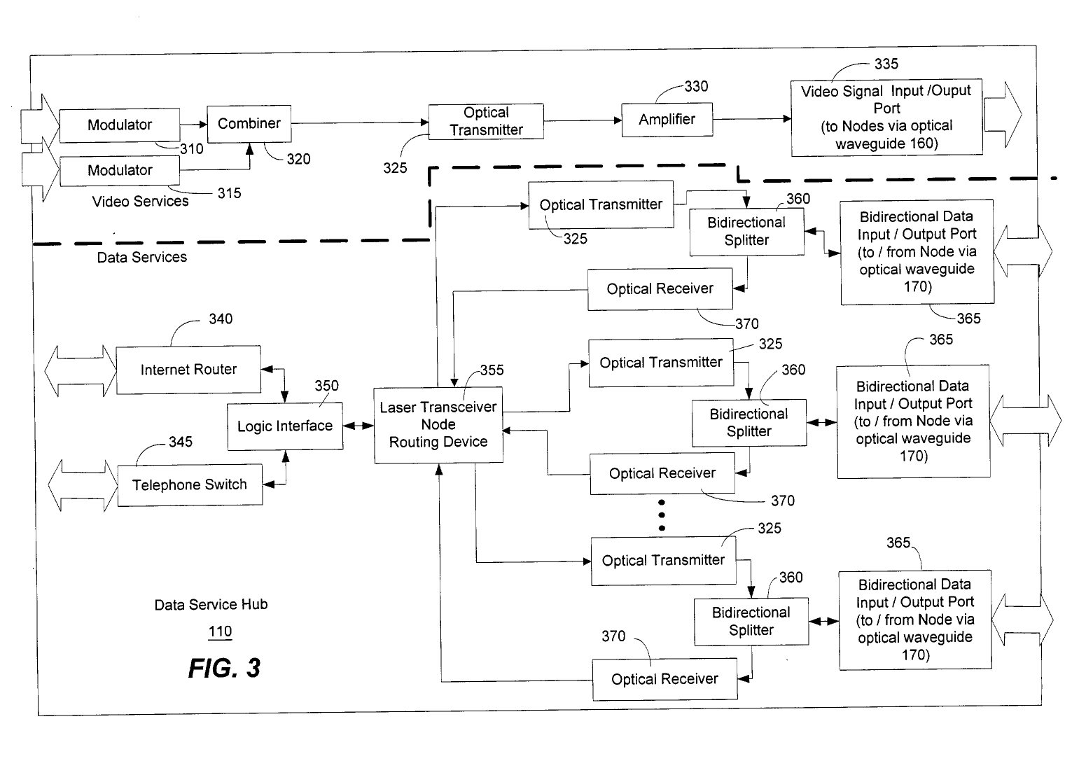

Referring now to FIG. 3, this functional block diagram illustrates an exemplary data service hub 110 of the present invention. The exemplary data service hub 110 illustrated in FIG. 3 is designed for a two trunk optical waveguide system. That is, this data service hub 110 of FIG. 3 is designed to send and receive optical signals to and from the outdoor laser transceiver node 120 along the first optical waveguide 160 and the second optical waveguide 170. With this exemplary embodiment, the second optical waveguide 170 supports bi-directional data flow. In this way, the third optical waveguide 180 discussed above is not needed.

The data service hub 110 can comprise one or more modulators 310, 315 that are designed to support television broadcast services. The one or more modulators 310, 315 can be analog or digital type modulators. In one exemplary embodiment, there can be at least 78 modulators present in the data service hub 110. Those skilled in the art will appreciate that the number of modulators 310, 315 can be varied without departing from the scope and spirit of the present invention.

The signals from the modulators 310, 315 are combined in a combiner 320 where they are supplied to an optical transmitter 325 where the radio frequency signals generated by the modulators 310, 315 are converted into optical form.

The optical transmitter 325 can comprise one of Fabry-Perot (F-P) Laser Transmitters, distributed feedback lasers (DFBs), or Vertical Cavity Surface Emitting Lasers (VCSELs). However, other types of optical transmitters are possible and are not beyond the scope of the present invention. With the aforementioned optical transmitters 325, the data service hub 110 lends itself to efficient upgrading by using off-the-shelf hardware to generate optical signals.

The optical signals generated by the optical transmitter 325 (often referred to as the unidirectional optical signals) are propagated to amplifier 330 such as an Erbium Doped Fiber Amplifier (EDFA) where the unidirectional optical signals are amplified. The amplified unidirectional optical signals are then propagated out of the data service hub 110 via a unidirectional signal output port 335 which is connected to one or more first optical waveguides 160.

The signal output port 335 is connected to one or more first optical waveguides 160 that support optical signals originating from the data service hub 110 to a respective laser transceiver node 120. The data service hub 110 illustrated in FIG. 3 can further comprise an Internet router 340. The data service hub 110 can further comprise a telephone switch 345 that supports telephony service to the subscribers of the optical network system 100. However, other telephony service such as Internet Protocol telephony can be supported by the data service hub 110.

If only Internet Protocol telephony is supported by the data service hub 110, then it is apparent to those skilled in the art that the telephone switch 345 could be eliminated in favor of lower cost Voice over Internet Protocol (VoIP) equipment. For example, in another exemplary embodiment (not shown), the telephone switch 345 could be substituted with other telephone interface devices such as a soft switch and gateway. But if the telephone switch 345 is needed, it may be located remotely from the data service hub 110 and can be connected through any of several conventional means of interconnection.

The data service hub 110 can further comprise a logic interface 350 that is connected to a laser transceiver node routing device 355. The logic interface 350 can comprise a Voice over Internet Protocol (VoIP) gateway when required to support such a service. The laser transceiver node routing device 355 can comprise a conventional router that supports an interface protocol for communicating with one or more laser transceiver nodes 120. This interface protocol can comprise one of gigabit or faster Ethernet or SONET protocols. However, the present invention is not limited to these protocols. Other protocols can be used without departing from the scope and spirit of the present invention.

The logic interface 350 and laser transceiver node routing device 355 can read packet headers originating from the laser transceiver nodes 120 and the internet router 340. The logic interface 350 can also translate interfaces with the telephone switch 345. After reading the packet headers, the logic interface 350 and laser transceiver node routing device 355 can determine where to send the packets of information.

The laser transceiver node routing device 355 can supply downstream data signals to respective optical transmitters 325. The data signals converted by the optical transmitters 325 can then be propagated to a bi-directional splitter 360. The optical signals sent from the optical transmitter 325 into the bi-directional splitter 360 can then be propagated towards a bi-directional data input/output port 365 that is connected to a second optical waveguide 170 that supports bi-directional optical data signals between the data service hub 110 and a respective laser transceiver node 120. Upstream optical signals received from a respective laser transceiver node 120 can be fed into the bi-directional data input/output port 365 where the optical signals are then forwarded to the bi-directional splitter 360.

From the bi-directional splitter 360, respective optical receivers 370 can convert the upstream optical signals into the electrical domain. The upstream electrical signals generated by respective optical receivers 370 are then fed into the laser transceiver node routing device 355. Each optical receiver 370 can comprise one or more photoreceptors or photodiodes that convert optical signals into electrical signals.

When distances between the data service hub 110 and respective laser transceiver nodes 120 are modest, the optical transmitters 325 can propagate optical signals at 1310 nm. But where distances between the data service hub 110 and the laser transceiver node are more extreme, the optical transmitters 325 can propagate the optical signals at wavelengths of 1550 nm with or without appropriate amplification devices.

Those skilled in the art will appreciate that the selection of optical transmitters 325 for each circuit may be optimized for the optical path lengths needed between the data service hub 110 and the outdoor laser transceiver node 120. Further, those skilled in the art will appreciate that the wavelengths discussed are practical but are only illustrative in nature. In some scenarios, it may be possible to use communication windows at 1310 and 1550 nm in different ways without departing from the scope and spirit of the present invention. Further, the present invention is not limited to a 1310 and 1550 nm wavelength regions. Those skilled in the art will appreciate that smaller or larger wavelengths for the optical signals are not beyond the scope and spirit of the present invention.

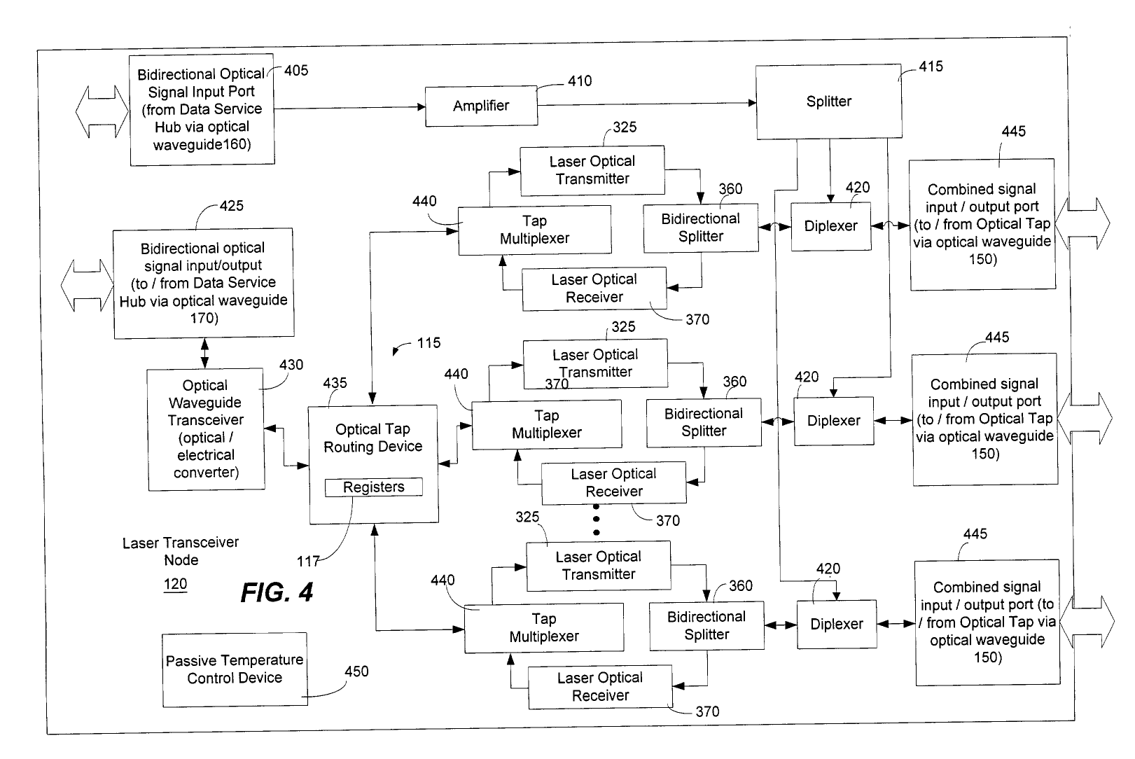

Referring now to FIG. 4, this Figure illustrates a functional block diagram of an exemplary outdoor laser transceiver node 120 of the present invention. In this exemplary embodiment, the laser transceiver node 120 can comprise an optical signal input port 405 that can receive optical signals propagated from the data service hub 110 that are propagated along a first optical waveguide 160. The optical signals received at the optical signal input port 405 can comprise broadcast video data. The optical signals received at the input port 405 are propagated to an amplifier 410 such as an Erbium Doped Fiber Amplifier (EDFA) in which the optical signals are amplified. The amplified optical signals are then propagated to a splitter 415 that divides the broadcast video optical signals among diplexers 420 that are designed to forward optical signals to predetermined groups of subscribers.

The laser transceiver node 120 can further comprise a bi-directional optical signal input/output port 425 that connects the laser transceiver node 120 to a second optical waveguide 170 that supports bi-directional data flow between the data service hub 110 and laser transceiver node 120. Downstream optical signals flow through the bi-directional optical signal input/output port 425 to an optical waveguide transceiver 430 that converts downstream optical signals into the electrical domain. The optical waveguide transceiver further converts upstream electrical signals into the optical domain. The optical waveguide transceiver 430 can comprise an optical/electrical converter and an electrical/optical converter.

Downstream and upstream electrical signals are communicated between the optical waveguide transceiver 430 and an optical tap routing device 435. The optical tap routing device 435 can manage the interface with the data service hub optical signals and can route or divide or apportion the data service hub signals according to individual tap multiplexers 440 that communicate optical signals with one or more optical taps 130 and ultimately one or more subscriber optical interfaces 140. The optical tap routing device 435 forms part of the security system 115 and can comprise one or more encryption registers 117 as will be described in further detail below with respect to FIGS. 6-7. The encryption registers 117 also form a part of the hardware for security system 115. The security system 115 can be embodied in software or hardware or both. It is noted that tap multiplexers 440 operate in the electrical domain to modulate laser transmitters in order to generate optical signals that are assigned to groups of subscribers coupled to one or more optical taps.

Optical tap routing device 435 is notified of available upstream data packets as they arrive, by each tap multiplexer 440. The optical tap routing device is connected to each tap multiplexer 440 to receive these upstream data packets. The optical tap routing device 435 relays the packets to the data service hub 110 via the optical waveguide transceiver 430. The optical tap routing device 435 can build a lookup table from these upstream data packets coming to it from all tap multiplexers 440 (or ports), by reading the source IP address of each packet, and associating it with the tap multiplexer 440 through which it came. This lookup table can then be used to route packets in the downstream path. As each packet comes in from the optical waveguide transceiver 430, the optical tap routing device looks at the destination IP address (which is the same as the source IP address for the upstream packets). From the lookup table the optical tap routing device can determine which port is connected to that IP address, so it sends the packet to that port. This can be described as a normal layer 3 router function as is understood by those skilled in the art.

The optical tap routing device 435 can assign multiple subscribers to a signal port. More specifically, the optical tap routing device 435 can service groups of subscribers with corresponding respective signal ports. The optical taps 130 logically coupled to respective tap multiplexers 440 can supply downstream optical signals to pre-assigned groups of subscribers who receive the downstream optical signals with the subscriber optical interfaces 140.

In other words, the optical tap routing device 435 can determine which tap multiplexer 440 is to receive a downstream electrical signal, or identify which of a plurality of optical taps 130 propagated an upstream optical signal (that is converted to an electrical signal). The optical tap routing device 435 can format data and implement the protocol required to send and receive data from each individual subscriber connected to a respective optical tap 130. The optical tap routing device 435 can comprise a computer or a hardwired apparatus that executes a program defining a protocol for communications with groups of subscribers assigned to individual ports.

Exemplary embodiments of programs defining the protocol is discussed in the following copending and commonly assigned non-provisional patent applications, the entire contents of which are hereby incorporated by reference: “Method and System for Processing Downstream Packets of an Optical Network,” filed on Oct. 26, 2001 in the name of Stephen A. Thomas et al. and assigned U.S. Ser. No. 10/045,652; and “Method and System for Processing Upstream Packets of an Optical Network,” filed on Oct. 26, 2001 in the name of Stephen A. Thomas et al. and assigned U.S. Ser. No. 10/045,584.

The signal ports of the optical tap routing device are connected to respective tap multiplexers 440. With the optical tap routing device 435, the laser transceiver node 120 can adjust a subscriber's bandwidth on a subscription basis or on an as-needed or demand basis. The laser transceiver node 120 via the optical tap routing device 435 can offer data bandwidth to subscribers in pre-assigned increments. For example, the laser transceiver node 120 via the optical tap routing device 435 can offer a particular subscriber or groups of subscribers bandwidth in units of 1, 2, 5, 10, 20, 50, 100, 200, and 450 Megabits per second (Mb/s). Those skilled in the art will appreciate that other subscriber bandwidth units are not beyond the scope of the present invention.

Electrical signals are communicated between the optical tap routing device 435 and respective tap multiplexers 440. The tap multiplexers 440 propagate optical signals to and from various groupings of subscribers. Each tap multiplexer 440 is connected to a respective optical transmitter 325. As noted above, each optical transmitter 325 can comprise one of a Fabry-Perot (F-P) laser, a distributed feedback laser (DFB), or a Vertical Cavity Surface Emitting Laser (VCSEL). Other laser technologies may be used within the scope of the invention. The optical transmitters produce the downstream optical signals that are propagated towards the subscriber optical interfaces 140. Each tap multiplexer 440 is also coupled to an optical receiver 370. Each optical receiver 370, as noted above, can comprise photoreceptors or photodiodes. Since the optical transmitters 325 and optical receivers 370 can comprise off-the-shelf hardware to generate and receive respective optical signals, the laser transceiver node 120 lends itself to efficient upgrading and maintenance to provide significantly increased data rates.

Each optical transmitter 325 and each optical receiver 370 are connected to a respective bi-directional splitter 360. Each bi-directional splitter 360 in turn is connected to a diplexer 420 which combines the unidirectional optical signals received from the splitter 415 with the downstream optical signals received from respective optical transmitter 325. In this way, broadcast video services as well as data services can be supplied with a single optical waveguide such as a distribution optical waveguide 150 as illustrated in FIG. 2. In other words, optical signals can be coupled from each respective diplexer 420 to a combined signal input/output port 445 that is connected to a respective distribution optical waveguide 150.

Unlike the conventional art, the laser transceiver node 120 does not employ a conventional router. The components of the laser transceiver node 120 can be disposed within a compact electronic packaging volume. For example, the laser transceiver node 120 can be designed to hang on a strand or fit in a pedestal similar to conventional cable TV equipment that is placed within the “last mile,” or subscriber proximate portions of a network. It is noted that the term, “last mile,” is a generic term often used to describe the last portion of an optical network that connects to subscribers.

Also because the optical tap routing device 435 is not a conventional router, it does not require active temperature controlling devices to maintain the operating environment at a specific temperature. In other words, the laser transceiver node 120 can operate in a temperature range between minus 40 degrees Celsius to 60 degrees Celsius in one exemplary embodiment.

While the laser transceiver node 120 does not comprise active temperature controlling devices that consume power to maintain temperature of the laser transceiver node 120 at a single temperature, the laser transceiver node 120 can comprise one or more passive temperature controlling devices 450 that do not consume power. The passive temperature controlling devices 450 can comprise one or more heat sinks or heat pipes that remove heat from the laser transceiver node 120. Those skilled in the art will appreciate that the present invention is not limited to these exemplary passive temperature controlling devices. Further, those skilled in the art will also appreciate the present invention is not limited to the exemplary operating temperature range disclosed. With appropriate passive temperature controlling devices 450, the operating temperature range of the laser transceiver node 120 can be reduced or expanded.

In addition to the laser transceiver node's 120 ability to withstand harsh outdoor environmental conditions, the laser transceiver node 120 can also provide high speed symmetrical data transmissions. In other words, the laser transceiver node 120 can propagate the same bit rates downstream and upstream to and from a network subscriber. This is yet another advantage over conventional networks, which typically cannot support symmetrical data transmissions as discussed in the background section above. Further, the laser transceiver node 120 can also serve a large number of subscribers while reducing the number of connections at both the data service hub 110 and the laser transceiver node 120 itself.

The laser transceiver node 120 also lends itself to efficient upgrading that can be performed entirely on the network side or data service hub 110 side. That is, upgrades to the hardware forming the laser transceiver node 120 can take place in locations between and within the data service hub 110 and the laser transceiver node 120. This means that the subscriber side of the network (from distribution optical waveguides 150 to the subscriber optical interfaces 140) can be left entirely intact during an upgrade to the laser transceiver node 120 or data service hub 110 or both.

The following is provided as an example of an upgrade that can be employed utilizing the principles of the present invention. In one exemplary embodiment of the invention, the subscriber side of the laser transceiver node 120 can service six groups of 16 subscribers each for a total of up to 96 subscribers. Each group of 16 subscribers can share a data path of about 450 Mb/s speed. Six of these paths represents a total speed of 6×450=2.7 Gb/s. In the most basic form, the data communications path between the laser transceiver node 120 and the data service hub 110 can operate at 1 Gb/s. Thus, while the data path to subscribers can support up to 2.7 Gb/s, the data path to the network can only support 1 Gb/s. This means that not all of the subscriber bandwidth is useable. This is not normally a problem due to the statistical nature of bandwidth usage.

An upgrade could be to increase the 1 Gb/s data path speed between the laser transceiver node 120 and the data service hub 110. This may be done by adding more 1 Gb/s data paths. Adding one more path would increase the data rate to 2 Gb/s, approaching the total subscriber-side data rate. A third data path would allow the network-side data rate to exceed the subscriber-side data rate. In other exemplary embodiments, the data rate on one link could rise from 1 Gb/s to 2 Gb/s then to 10 Gb/s, so when this happens, a link can be upgraded without adding more optical links.

The additional data paths (bandwidth) may be achieved by any of the methods known to those skilled in the art. It may be accomplished by using a plurality of optical waveguide transceivers 430 operating over a plurality of optical waveguides, or they can operate over one optical waveguide at a plurality of wavelengths, or it may be that higher speed optical waveguide transceivers 430 could be used as shown above. Thus, by upgrading the laser transceiver node 120 and the data service hub 110 to operate with more than a single 1 Gb/s link, a system upgrade is effected without having to make changes at the subscribers' premises.

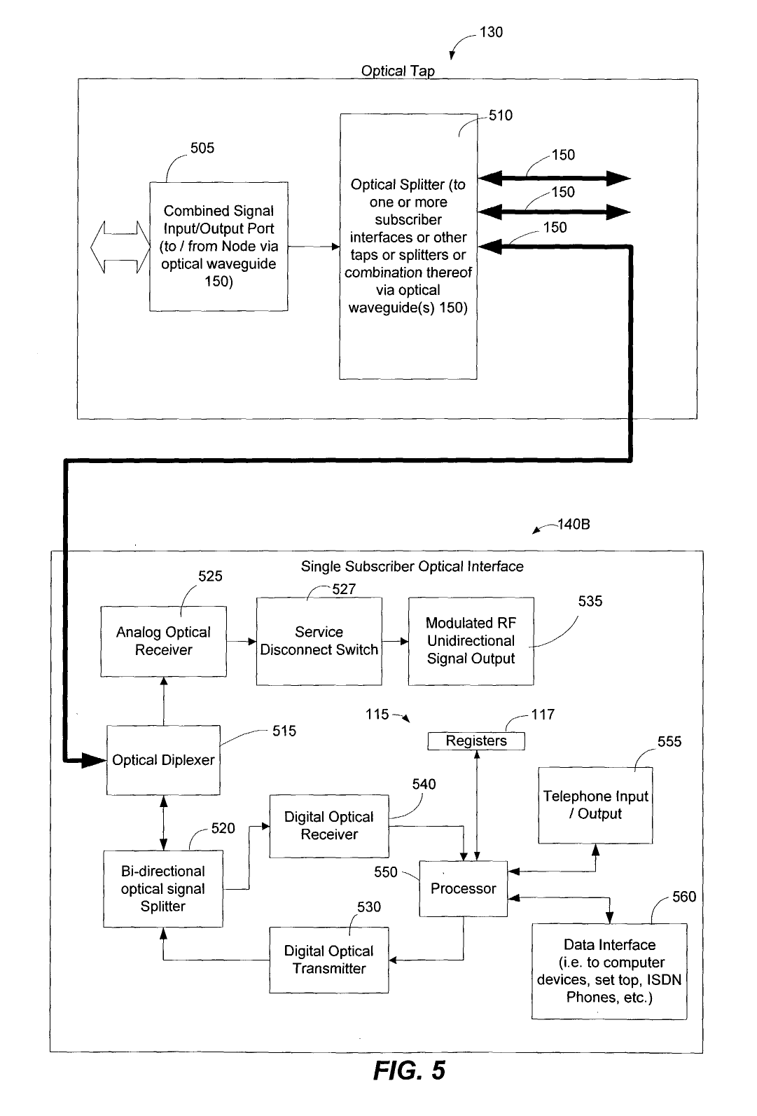

Referring now to FIG. 5, this Figure is a functional block diagram illustrating an optical tap 130 connected to a subscriber optical interface 140 by a single optical waveguide 150 according to one exemplary embodiment of the present invention. The optical tap 130 can comprise a combined signal input/output port 505 that is connected to a distribution optical waveguide 150 that is connected to a laser transceiver node 120. As noted above, the optical tap 130 can comprise an optical splitter 510 that can be a 4-way or 8-way optical splitter. Other optical taps having fewer or more than 4-way or 8-way splits are not beyond the scope of the present invention. The optical tap can divide downstream optical signals to serve respective subscriber optical interfaces 140. In the exemplary embodiment in which the optical tap 130 comprises a 4-way optical tap, such an optical tap can be of the pass-through type, meaning that a portion of the downstream optical signals is extracted or divided to serve a 4-way splitter contained therein, while the rest of the optical energy is passed further downstream to other distribution optical waveguides 150.

The optical tap 130 is an efficient coupler that can communicate optical signals between the laser transceiver node 120 and a respective subscriber optical interface 140. Optical taps 130 can be cascaded, or they can be connected in a star architecture from the laser transceiver node 120. As discussed above, the optical tap 130 can also route signals to other optical taps that are downstream relative to a respective optical tap 130.

The optical tap 130 can also connect to a limited or small number of optical waveguides so that high concentrations of optical waveguides are not present at any particular laser transceiver node 120. In other words, in one exemplary embodiment, the optical tap can connect to a limited number of optical waveguides 150 at a point remote from the laser transceiver node 120 so that high concentrations of optical waveguides 150 at a laser transceiver node can be avoided. However, those skilled in the art will appreciate that the optical tap 130 can be incorporated within the laser transceiver node 120 with respect to another exemplary embodiment (not shown) of the laser transceiver node 120.

The subscriber optical interface 140 functions to convert downstream optical signals received from the optical tap 130 into the electrical domain that can be processed with appropriate communication devices. The subscriber optical interface 140 further functions to convert upstream electrical signals into upstream optical signals that can be propagated along a distribution optical waveguide 150 to the optical tap 130. The subscriber optical interface 140 can comprise an optical diplexer 515 that divides the downstream optical signals received from the distribution optical waveguide 150 between a bi-directional optical signal splitter 520 and an analog optical receiver 525. A service disconnect switch 527 can be positioned between the analog optical receiver 525 and modulated RF unidirectional signal output 535.

The optical diplexer 515 can receive upstream optical signals generated by a digital optical transmitter 530. The digital optical transmitter 530 converts electrical binary/digital signals to optical form so that the optical signals can be transmitted back to the data service hub 110. Conversely, the digital optical receiver 540 converts optical signals into electrical binary/digital signals so that the electrical signals can be handled by processor 550.

The analog optical receiver 525 can convert the downstream broadcast optical video signals into modulated RF television signals that are propagated out of the modulated RF unidirectional signal output 535. The modulated RF unidirectional signal output 535 can feed to RF receivers such as television sets (not shown) or radios (not shown). The analog optical receiver 525 can process analog modulated RF transmission as well as digitally modulated RF transmissions for digital TV applications.

The bi-directional optical signal splitter 520 can propagate combined optical signals in their respective directions. That is, downstream optical signals entering the bi-directional optical splitter 520 from the optical diplexer 515, are propagated to the digital optical receiver 540. Upstream optical signals entering it from the digital optical transmitter 530 are sent to optical diplexer 515 and then to optical tap 130. The bi-directional optical signal splitter 520 is connected to a digital optical receiver 540 that converts downstream data optical signals into the electrical domain. Meanwhile the bi-directional optical signal splitter 520 is also connected to a digital optical transmitter 530 that converts upstream electrical signals into the optical domain.

The digital optical receiver 540 can comprise one or more photoreceptors or photodiodes that convert optical signals into the electrical domain. The digital optical transmitter can comprise one or more lasers such as the Fabry-Perot (F-P) Lasers, distributed feedback lasers, and Vertical Cavity Surface Emitting Lasers (VCSELs). It can also comprise a wideband optical emitter, such as a light emitting diode.

The digital optical receiver 540 and digital optical transmitter 530 are connected to a processor 550 that selects data intended for the instant subscriber optical interface 140 based upon an embedded address. The data handled by the processor 550 can comprise one or more of telephony and data services such as an Internet service. The processor 550 is connected to a telephone input/output 555 that can comprise an analog interface.

The processor 550 is also connected to a data interface 560 that can provide a link to computer devices, set top boxes, ISDN phones, and other like devices. Alternatively, the data interface 560 can comprise an interface to a Voice over Internet Protocol (VoIP) telephone or Ethernet telephone. The data interface 560 can comprise one of Ethernet's (10BaseT, 100BaseT, Gigabit) interface, HPNA interface, a universal serial bus (USB) an IEEE1394 interface, an ADSL interface, and other like interfaces. The processor can comprise encryption registers 117 for security algorithms as will be discussed in further detail below with respect to FIGS. 6-7.

Exemplary Secure Communications System and Method

Referring now to FIG. 6, this figure illustrates an exemplary shift register 600 according to one embodiment of the present invention. The exemplary shift register 600 can comprise a feedback shift register. More specifically, the shift register 600 can comprise a linear feedback shift register (LFSR). While the exemplary shift register 600 illustrated in FIG. 6 is a 5-bit shift register, other sizes of the shift register are not beyond the scope of the present invention. For example, the present invention can comprise shift registers having sizes of 38, 43, and 47 bits.

Those skilled in the art recognized that each time a bit is needed, all of the bits in the shift register are shifted by one bit in the left direction. The new right-most bit 605 is computed as a function of other bits 610, 615 in the register 600. The output of the shift register 600 is one bit, often referred to as the least significant bit 610. The period of a shift register is the length of the output sequence before the sequence starts repeating.

For the feedback function of the exemplary linear feedback shift register 600 illustrated in FIG. 6, the function is simply the logical exclusive “OR” of the least significant bit 610 and another bit or tap 615. The other tap or bit 615 that is part of the feedback function that produces the new right-most bit 605 happens to be the third tap or bit of the shift register 600. However, other taps or bits of the shift register that can provide feedback for the least significant bit 610 are not beyond the scope of the present invention. Other exemplary feedback top locations are illustrated and discussed below with respect to FIG. 7.

To decrease the linear properties of the shift register 600, the output bit or least significant bit 610 is not used directly by the present invention. Instead, the present invention employs a non-linear filtering function that is a combination of several bits in the exemplary shift register 600. The actual output 625 of the shift register 600 comprises the exclusive “OR” 635 of two quantities: (a) the shift register output or least significant bit 610 and (b) the logical “AND” 630 of the second tap 645 and fourth tap 640. However, other bits or taps for the logical “AND” operation are not beyond the scope and spirit of the present invention. For example, different bits are tapped for the logical “AND” operation 630 as will be discussed and illustrated below with respect to FIG. 7.

While different bits or taps can be used for the logical “AND” operation 630, such taps are selected according to the specific mathematical properties known to those skilled in the art for producing non-linear functions. The non-linear filter function of the present invention may be described by the following polynomial:

g(x)=x₄+x₃x₁

or alternatively the equation may be expressed as follows:

g(x)=(3,1).

Referring now to FIG. 7, this figure illustrates the group or set 700, 117 of exemplary shift registers 705, 710, and 715 according to one exemplary embodiment of the present invention. Similar to the shift register illustrated in FIG. 6, the shift registers 705, 710, and 715 illustrated in FIG. 7 can also comprise linear feedback shift registers. However, other types of shift registers are not beyond the scope and spirit of the present invention.

The first shift register 705 of the set or group of registers 700 comprises a five bit shift register. The right most or new bit 720 is a function of the third bit or tap 725 and the fifth or least significant bit 730. Specifically, the right most new bit 720 is calculated from the exclusive “OR” of the second bit 725 and the least significant bit 730.

Once the exemplary shift register 705 is clocked, the filtered output of the register 705 is calculated from two operations. The first operation occurs between the second tap 735 and the fourth tap 740. Specifically, the first operation comprises the logical “AND” 750 between the second tap 735 and the fourth tap 740. The second operation for completing the filtering operation comprises the exclusive “OR” 745 of two quantities: (a) the shift register output of the least significant bit 730 and (b) the logical “AND” 750 between the second tap or bit 735 and the fourth tap or bit 740.

The second tap 735 of the exemplary first shift register 705 has been designated as a clock tap. The output of the second tap 735 is fed into a majority clock function 755. The majority clock function 755 can comprise an operation of determining a maximum value from each clock tap that feeds into the majority clock function 755. Therefore, the majority clock function 755 can be an operation or function that depends on the data received from clock taps 735, 760, and 765. For each register 705, 710, and 715, one is not clocked unless its clock tap value matches the majority clock value that is a result of the majority clock function 755. If the clock tap of a particular shift register does not match the majority clock value, then the particular register would not be clocked. This means that for a register that is not clocked, a new right most bit would not be calculated and all bits in the particular register will remain the same or unchanged.

Similar to the shift register illustrated in FIG. 6, the shift register 705 illustrated in FIG. 7 calculates the right-most new bit 720 by taking the exclusive “OR” of the third bit 725 and the fifth or least significant bit 730. However, as noted above, the bits or taps for the logical “Exclusive OR” or “XOR” operations 770, 770′, and 770″ can be a function of taps that are different than those illustrated in FIG. 6.

The non-linear output of the second shift register 710 can comprise the exclusive “OR” 745′ of the following two quantities: (a) the shift register output or least significant bit 785 and (b) the logical “AND” 750′ of the second bit 780 and the fifth bit 785.

The three exclusive “OR” outputs 745, 745′, and 745″ can be combined into a single output. Specifically, the output of each register 705, 710, and 715 can be combined by taking a second exclusive “OR” operation relative to the first exclusive “OR” operations 745′ taken at each individual register 705, 710, 715. The output 797 of the second exclusive “OR” operation 795 typically comprises one bit of a keystream that will later combined with plain text.

The present invention can employ multiple groups or sets 700 of shift registers that operate in parallel to produce individual bits of the keystream. The number of bits for each register in a group can be sized such that the total bits of a set or group is approximately 128 bits. In one exemplary embodiment of the present invention, eight groups or sets 700 are employed to produce individual bits of the resulting keystream. Tables I, II, III, IV, V, VI, VII, and VIII below provide exemplary configurations and exemplary sizes for the LFSR type registers according to the present invention.

TABLE I
Exemplary LFSR Set #1
LFSR Combination 0

| LFSR 0a (38 bits) | |
|---|---|
| Feedback Taps | 37 32 29 27 26 21 20 14 12 11 10 9 8 5 2 0 |
| Clock Tap | 22 |
| Output Filter | 37 (36, 33) (32, 29) (28, 25, 22) |
| LFSR 0b (43 bits) | |
| Feedback Taps | 42 5 3 2 |
| Clock Tap | 25 |
| Output Filter | 42 (41, 39) (38, 36) (35, 33, 31) |
| LFSR 0c (47 bits) | |
| Feedback Taps | 46 4 |
| Clock Tap | 27 |
| Output Filter | 46 (45, 40) (39, 34) (33, 28, 23) |

TABLE II
Exemplary LFSR Set #2
LFSR Combination 1

| LFSR 1a (38 bits) | |
|---|---|
| Feedback Taps | 37 36 34 31 28 27 26 25 24 22 16 15 10 9 7 4 |
| Clock Tap | 15 |
| Output Filter | 37 (3, 0) (7, 4) (14, 11, 8) |
| LFSR 1b (43 bits) | |
| Feedback Taps | 42 39 38 36 |
| Clock Tap | 18 |
| Output Filter | 42 (2, 0) (5, 3) (10, 8, 6) |
| LFSR 1c (47 bits) | |
| Feedback Taps | 46 41 |
| Clock Tap | 20 |
| Output Filter | 46 (5, 0) (11, 6) (22, 17, 12) |

TABLE III
Exemplary LFSR Set #3
LFSR Combination 2

| LFSR 2a (38 bits) | |
|---|---|
| Feedback Taps | 37 23 21 18 17 16 14 10 9 7 4 0 |
| Clock Tap | 21 |
| Output Filter | 37 (35, 32) (31, 28) (27, 24, 21) |
| LFSR 2b (43 bits) | |
| Feedback Taps | 42 29 16 5 4 3 2 0 |
| Clock Tap | 24 |
| Output Filter | 42 (40, 38) (37, 35) (34, 32, 30) |
| LFSR 2c (47 bits) | |
| Feedback Taps | 46 32 18 4 |
| Clock Tap | 26 |
| Output Filter | 46 (44, 39) (38, 33) (32, 27, 22) |

TABLE IV
Exemplary LFSR Set #4
LFSR Combination 3

| LFSR 3a (38 bits) | |
|---|---|
| Feedback Taps | 37 36 32 29 27 26 22 20 19 18 15 13 |
| Clock Tap | 16 |
| Output Filter | 37 (4, 1) (8, 5) (15, 12, 9) |
| LFSR 3b (43 bits) | |
| Feedback Taps | 42 41 39 38 37 36 25 12 |
| Clock Tap | 19 |
| Output Filter | 42 (3, 1) (6, 4) (11, 9, 7) |
| LFSR 3c (47 bits) | |
| Feedback Taps | 46 41 27 13 |
| Clock Tap | 21 |
| Output Filter | 46 (4, 1) (12, 7) (21, 18, 13) |

TABLE V
Exemplary LFSR Set #5
LFSR Combination 4

| LFSR 4a (38 bits) | |
|---|---|
| Feedback Taps | 37 24 22 11 7 5 3 1 |
| Clock Tap | 20 |
| Output Filter | 37 (34, 31) (30, 27) (26, 23, 20) |
| LFSR 4b (43 bits) | |
| Feedback Taps | 42 34 26 19 18 17 12 5 4 3 |
| Clock Tap | 23 |
| Output Filter | 42 (39, 37) (36, 34) (33, 31, 29) |
| LFSR 4c (47 bits) | |
| Feedback Taps | 46 4 3 0 |
| Clock Tap | 25 |
| Output Filter | 46 (43, 38) (37, 32) (31, 26, 21) |

TABLE VI
Exemplary LFSR Set #6
LFSR Combination 5

| LFSR 5a (38 bits) | |
|---|---|
| Feedback Taps | 37 35 33 31 29 25 14 12 |
| Clock Tap | 17 |
| Output Filter | 37 (5, 2) (9, 6) (16, 13, 10) |
| LFSR 5b (43 bits) | |
| Feedback Taps | 42 38 37 36 29 24 23 22 15 7 |
| Clock Tap | 20 |
| Output Filter | 42 (4, 2) (7, 5) (12, 10, 8) |
| LFSR 5c (47 bits) | |
| Feedback Taps | 46 45 42 41 |
| Clock Tap | 22 |
| Output Filter | 46 (5, 2) (13, 8) (22, 19, 14) |

TABLE VII
Exemplary LFSR Set #7
LFSR Combination 6

| LFSR 6a (38 bits) | |
|---|---|
| Feedback Taps | 37 5 4 0 |
| Clock Tap | 19 |
| Output Filter | 37 (33, 30) (29, 26) (25, 22, 19) |
| LFSR 6b (43 bits) | |
| Feedback Taps | 42 29 28 25 17 14 13 9 4 3 |
| Clock Tap | 22 |
| Output Filter | 42 (38, 36) (35, 33) (32, 30, 28) |
| LFSR 6c (47 bits) | |
| Feedback Taps | 46 32 18 10 7 4 |
| Clock Tap | 24 |
| Output Filter | 46 (42, 37) (36, 31) (30, 25, 20) |

TABLE VIII
Exemplary LFSR Set #7
LFSR Combination 7

| LFSR 7a (38 bits) | |
|---|---|
| Feedback Taps | 37 36 32 31 |
| Clock Tap | 18 |
| Output Filter | 37 (6, 3) (10, 7) (17, 14, 11) |
| LFSR 7b (43 bits) | |
| Feedback Taps | 42 38 37 32 28 27 24 16 13 12 |
| Clock Tap | 21 |
| Output Filter | 42 (5, 3) (8, 6) (13, 11, 9) |
| LFSR 7c (47 bits) | |
| Feedback Taps | 46 41 38 35 27 13 |
| Clock Tap | 23 |
| Output Filter | 46 (6, 3) (14, 9) (23, 20, 15) |

As listed in Tables I through VIII, the shift registers for each of the groups or sets can comprise registers having 38, 43, and 47 bit lengths. Their initial state of a total of 128 bits can comprise the traffic encryption key. In one exemplary embodiment, the same traffic encryption key initializes all eight combined or groups of shift registers.

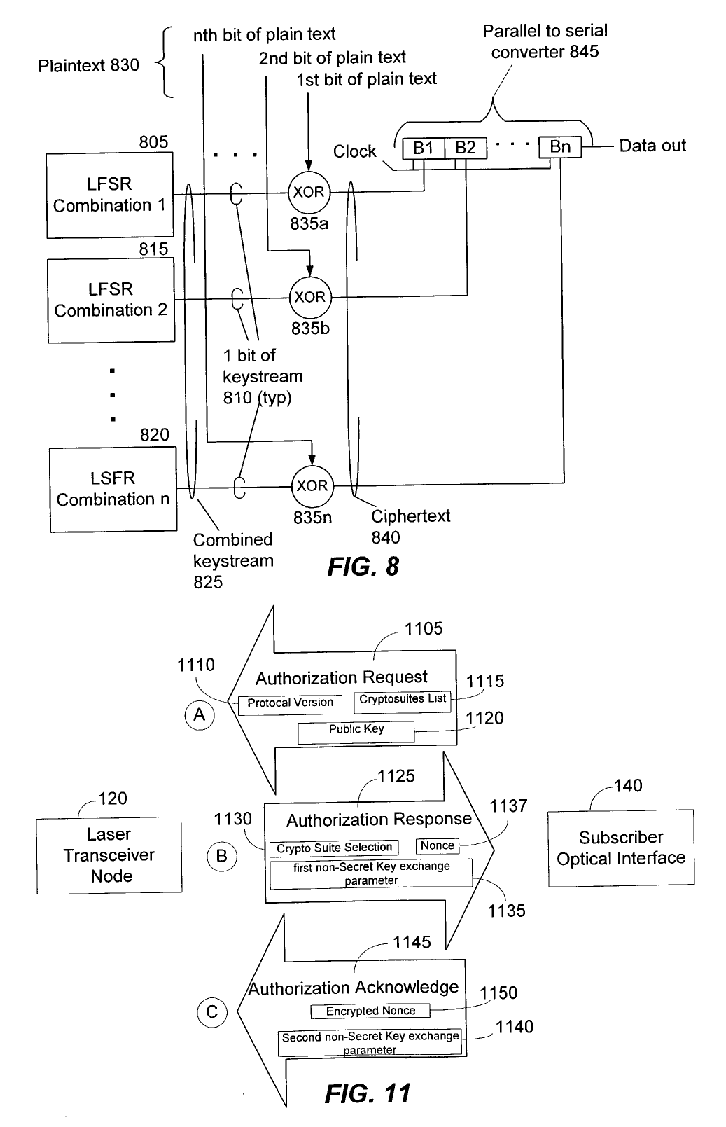

The first 1,031 bytes of each keystream produced by each group or set are discarded. The next byte can comprise the 1,032 byte of the keystream and can be exclusive “ORed” with the first byte of plain text (as illustrated in FIG. 8) to create the first byte of ciphertext.

FIG. 8 illustrates how ciphertext 840 can be produced by one exemplary embodiment of the present invention. A first LFSR combination 805 is used to generate a random bit sequence which will be used to encrypt the first bit Bi of each byte of cyphertext 840 that is transmitted to one subscriber. For example, the first LFSR combination can comprise the group of set 700 illustrated in FIG. 7. A second LFSR combination 815 does the same for the second bit of each byte transmitted to the same subscriber, and so on, through the n^{th} set of an LFSR combination 820. In a preferred, yet exemplary, embodiment of the invention, eight sets of LFSR combinations 805 through 820 are used for each subscriber. One set of LFSR combination is illustrated in FIG. 7 in a simplified form. Exemplary sets of LFSR combinations used in a preferred, yet exemplary, embodiment are illustrated as Tables I through VIII.

The collective output of the LFSR combinations 805 through 820 is referred to as the combined keystream 835. In a preferred, yet exemplary, embodiment, the combined keystream 835 comprises eight bits B1-B_{N} generated at a time from eight sets of LFSR combinations. It is possible to use fewer or more LFSR combinations as is understood by those skilled in the art. Each bit of the combined keystream 835 is exclusive OR'ed with a corresponding bit of plaintext 830 in exclusive OR gates 835a through 835n. The exclusive OR logical function is well known to those skilled in the art. If the bit in the combined keystream 835 is a 1, then the corresponding plaintext 830 bit is changed from a 1 to a 0 or from a 0 to a 1. If the bit in the combined keystream 835 is a 0, then the corresponding plaintext 830 bit is not changed. The output of the XOR gates 835a through 835n is eight bits B1-B_{N} of cipher text 840. These eight bits B1-B_{N} are loaded into a parallel-to-serial converter 845 which could be part of tap multiplexer 440. After these eight bits B1-B_{N} are loaded into parallel to serial converter 845, then eight more bits of plaintext 830 are presented to the exclusive OR gates 835a through 835n, the eight LFSR combinations 805 through 820 are also incremented or clocked to their next state as described above, and the process starts again. Those skilled in the art recognize that decryption can use the exact same procedure but in reverse to recover the plaintext 830 from the ciphertext 840.

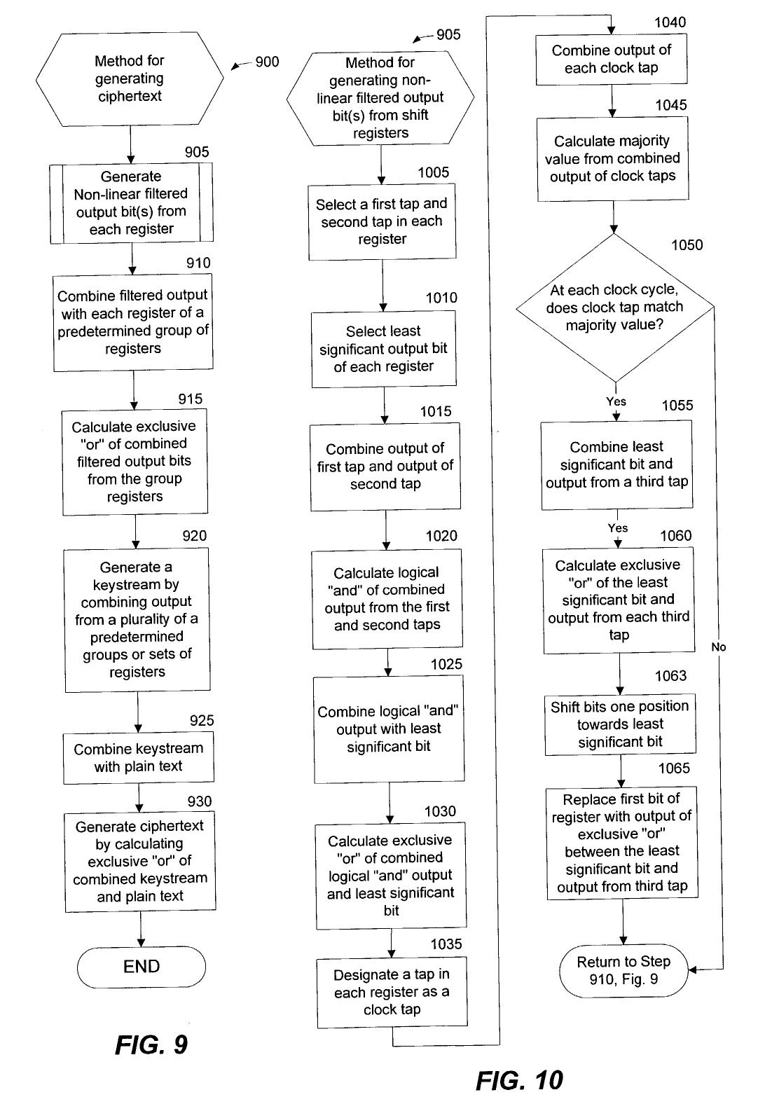

Referring now to FIG. 9, this Figure is a logic flow diagram illustrating an exemplary method 900 for generating ciphertext. The description of the flow charts in the this detailed description are represented largely in terms of processes and symbolic representations of operations by conventional computer components, including a processing unit (a processor), memory storage devices, connected display devices, and input devices. Furthermore, these processes and operations may utilize conventional discrete hardware components or other computer components in a heterogeneous distributed computing environment, including remote file servers, computer servers, and memory storage devices. Each of these conventional distributed computing components can be accessible by the processor via a communication network.

The processes and operations performed below may include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the following process in accordance with the teachings described herein.

The present invention may comprise a computer program or hardware or a combination thereof which embodies the functions described herein and illustrated in the appended flow charts. However, it should be apparent that there could be many different ways of implementing the invention in computer programming or hardware design, and the invention should not be construed as limited to any one set of computer program instructions.

Further, a skilled programmer would be able to write such a computer program or identify the appropriate hardware circuits to implement the disclosed invention without difficulty based on the flow charts and associated description in the application text. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the remaining Figures illustrating other process flows.

Further, certain steps in the process described below must naturally precede others for the present invention to function as described. However, the present invention is not limited to the order of the steps described if such order or sequence does not alter the functionality of the present invention. That is, it is recognized that some steps may be performed before or after other steps without departing from the scope and spirit of the present invention.

Referring again to FIG. 9, routine 905 is the first routine of the process where output bits from each shift register (such as shift register 705, 710, and 715) are generated. Next, in Step 910, the filtered output bit of each register of a predetermined group of registers (such as the set of group 700 as illustrated in FIG. 7) can be combined. Next, in Step 915, the exclusive “OR” 795 of the combined output bits from the group or set 700 of registers is calculated. In Step 920, a keystream 825 can be generated by combining outputs from a plurality of a predetermined groups or sets 805, 815, 820 of registers. Next, in Step 925, the keystream 825 is combined with the plain text 830. And in Step 930, ciphertext 840 can be generated by calculating the exclusive “OR” of the combined keystream 825 and plain text 830.

Referring now to FIG. 10, this figure illustrates a submethod 905 for generating non-linear filtered output bits from shift registers. Step 1005 is the first step of the submethod 905 in which a first tap such as tap 735 and a second tap such as tap 740 of the linear feedback shift register 705 in FIG. 7 are selected. Next, a least significant output bit such as 730 is selected. Next, in Step 1015, the output of the first tap 735 and second tap 740 are combined.

In Step 1020, the logical “AND” 750 of the combined output from the first and second taps 735, 740 is calculated. In Step 1025, the logical “AND” output is combined with the least significant bit 730. Next, in Step 1030, the exclusive “OR” 745 of the combined logical “AND” output and the least significant bit 745 is calculated.

In Step 1035, a tap such as tap 735 is designated as a clock tap. In Step 1040, the output of each clock tap is combined, such as in the majority clock function 755. A majority value from the combined output of respective clock taps is calculated. In decision Step 1050, it is determined at each clock cycle, whether a particular clock tap matches the majority value. If the inquiry to decision Step 1050 is negative, then the “NO” branch is followed and the process returns to Step 910 of FIG. 9.

If the inquiry to decision step 1050 is positive, then the “YES” branch is followed to Step 1055 in which the least significant bit 730 and output from a third tap such as tap 725 are combined. In Step 1060, the exclusive “OR” 770 of the least significant bit 730 and output from the third tap 725 is calculated. In Step 1063, the bits in the shift register 705 are shifted towards the least significant bit 730. In Step 1065, the first bit 720 of the register 705 is replaced with the exclusive “OR” 770 between the least significant bit 730 and output from the third tap 725, based on the bit values before the shift of step 1063. The process then returns to Step 910 of FIG. 9.

Referring now to FIG. 11, this figure illustrates some exemplary messages that can be exchanged between two parties such that one party can authenticate and exchange non-secret key exchange parameters with another party. Specifically, a subscriber optical interface 140 can transmit a first message A to the laser transceiver node 120. The first message A can comprise an authorization request 1105. The authorization request 1105 can comprise at least one of the following message objects: a protocol version 1110, a crypto suites list 1115, and a public key 1120 that can be one key of an RSA public-private key pair and is usually referred to as part of the public key certificate.

In response to the authorization request 1105, the laser transceiver node 120 can respond with a second message B that is sent to the subscriber optical interface 140. The second message B can comprise an authorization response 1125. The authorization response 1125 can further comprise at least one of the following message objects: a cryptosuite selection 1130, a non-secret key exchange parameter 1135, and a nonce 1137. The authorization response 1125 comprising the aforementioned message objects can be encrypted with a public key 1120 that is part of the public key certificate sent by the subscriber optical interface 140. While reference numeral 1120 of FIG. 11 refers to just a public key, those skilled in the art recognize that the public key 1120 is the operative portion of the public key certificate for this discussion. The subscriber optical interface 140 can also send the entire public key certificate that can comprise the public key 1120. Meanwhile, the nonce 1137 can comprise a random number.

The nonce 1137 or random number can be computed by a pseudo random number generator (PRNG). The laser transceiver node 120 in one exemplary embodiment can employ the Yarrow architecture developed by Kelsey, Schneier, and Ferguson. The Yarrow architecture combines existing cryptographic functions—a secure hash algorithm and a block cipher algorithm—to create a cryptographically secure generator.

For the hash algorithm of one exemplary embodiment, the laser transceiver node 120 can employ a 256-bit secure hash algorithm (SHA-256). Since the algorithms provide for a 256-bit “key” for the random number generator, the implementation in such an exemplary embodiment can be described as “Yarrow-256.”

The laser transceiver node 120 can obtain initial seed values with the pseudo random number generator from several sources. The laser transceiver node 120 uses the sources both for initial seeds and for periodic re-seeding of the pseudo random number carrier. In one exemplary embodiment, the seed values can be drawn from a special purpose hardware module comprising a reverse-biased diode operated in the breakdown region, amplification of the resulting junction noise, and analog-to-digital conversion.

In another exemplary embodiment, the seed values can be derived from a few least significant bits from the time of day. In other exemplary embodiments, a seed can be derived from a few least significant bits from the measured interval between packet arrivals on the network interface. In other exemplary embodiments, the initial seeds can be derived from the Ethernet frame check sequence from arbitrary frames arriving on the network interface. The seed comprises a source of entropy.

Upon receiving the second message B from the laser transceiver node 120, the subscriber optical interface 140 can decrypt message B to recover the Laser Transceiver Node's 140 non-secret key exchange parameter 1135 and the nonce 1137. The subscriber optical interface 140 can generate its own secret key parameter such as small letter y and derive a non-secret key exchange parameter 1140 that can be shared with the laser transceiver node 120. In response to the second message B, the subscriber optical interface 140 generates a third message C that can comprise an authorization acknowledge message 1145. The authorization acknowledge message 1145 can further comprise the subscriber optical interface's 140 non-secret key exchange parameter 1140 and the nonce 1150. The nonce 1150 can be encrypted with the shared encryption key. In response to the third message C, the laser transceiver node 120 can take the subscriber optical interface's 140 non-secret key exchange parameter 1140 and its first secret key parameter such as small letter x to derive the shared encryption key.

The three messages described above (messages A, B, C) combine public key cryptography and a key exchange protocol to take advantage of the benefits of both types of key distribution. Specifically, the present invention employs a public key algorithm as a carrier to transport the parameters of a key exchange protocol to verify the identity of the subscriber optical interface 140, to establish a symmetrical key to use for data encryption, and to provide perfect forward secrecy.

In order to agree on a secret key, the Diffie-Hellman key exchange protocol is used, as described below. Both the laser transceiver node 120 and the subscriber optical interface agree on n and g such that g is primitive mod n. These two parameters can be exchanged freely between the laser transceiver node 120 and the subscriber optical interface 140 since they do not have to be a secret. In other words, the laser transceiver node 120 and the subscriber optical interface 140 can agree to these two integers n and g over an insecure channel. Alternatively, the two numbers n and g may be fixed in the software by the manufacturer.

The first non-secret key exchange parameter 1135 comprises the following:

X=g^{x} mod n (1.0)

where small letter x, the first secret key parameter, comprises a large random integer selected by or assigned to the laser transceiver node 120. In other words, the first non-secret key exchange parameter 1135 comprises capital letter X in equation (1.0) above.

The second non-secret key exchange parameter 1140 comprises the following:

Y=g^{y} mod n (1.1)

where small letter y, the second secret key parameter, comprises a large random integer selected by the subscriber optical interface 140. In other words, the second non-secret key exchange parameter comprises capital letter Y in equation (1.1) above.

The subscriber optical interface 140 calculates the following upon receiving the first non-secret key exchange parameter 1135 comprising X from the laser transceiver node 120:

k=X^{y} mod n (1.2)

where k comprises the shared secret symmetric encryption key.

Similarly, after receiving the third message C, the laser transceiver node 120 can calculate the shared secret key from the following:

k′=Y^{x} mod n (1.3)

Both k and k′ are equal to g^{xy} mod n, as is understood by those skilled in the art.

Anyone monitoring the communication channel between the laser transceiver node 120 and the subscriber optical interface 140 cannot compute the secret key k or k′ since only the parameters n, g, X, and Y are exchanged between the laser transceiver node 120 and the subscriber optical interface 140. In some preferred, yet exemplary, embodiments n and g may be pre-programmed and not actually exchanged. Unless an attacker can compute the discrete logarithm and recover x or y (which is usually an extremely difficult task), the attacker does not solve the problem. Those skilled in the art recognize that the choice of g and n can have a substantial impact on the security of this key exchange algorithm.

The number (n−1)/2 should also be a prime number. And further, n should be large since the security of the system is based on the difficulty of factoring numbers the same size as n. Any g can be chosen such that g is primitive mod n. The value g can be selected such that it is generally small, such as a 1-digit number. Further, g does not really have to be primitive; it just has to generate a large subgroup of the multiplicitive group mod n.

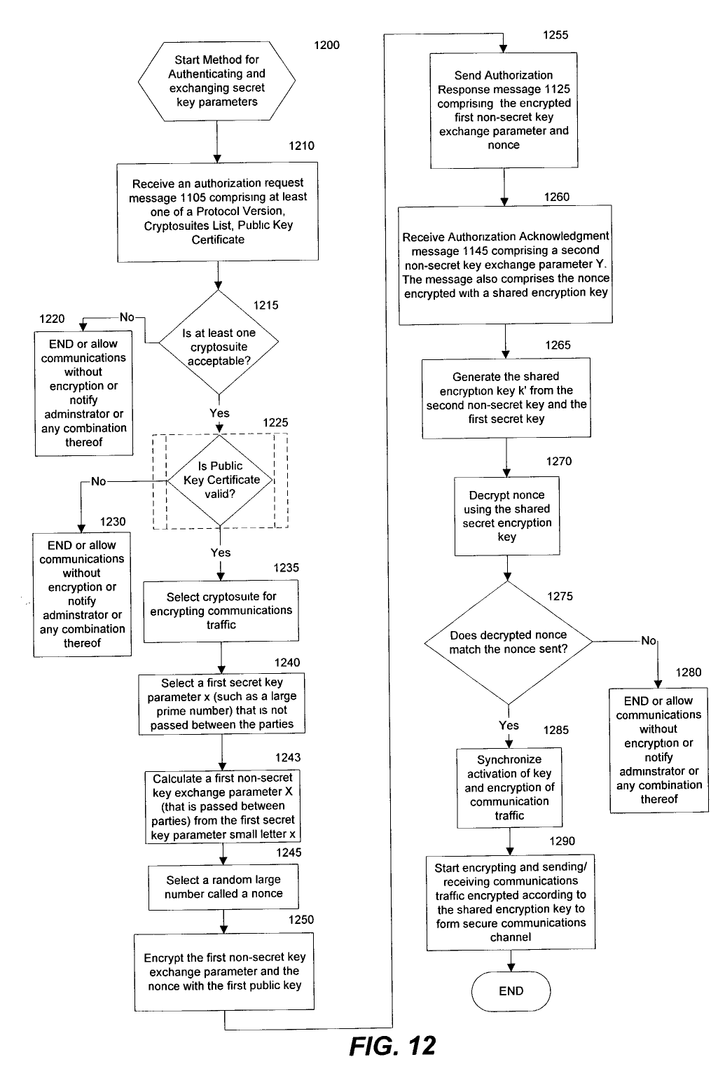

Referring now to FIG. 12, this figure illustrates a logic flow diagram for a method for authenticating and exchanging non-secret key exchange parameters for deriving a shared secret key. The method 1200 generally corresponds to the steps taken by the laser transceiver node 120 to authenticate and exchange non-secret key parameters 1135, 1140 with the subscriber optical interface 140. The method 1200 illustrated in FIG. 12 is explained from the perspective of the laser transceiver node 120.

The method 1200 starts with step 1210 in which an authentication request message 1105 can be received from the subscriber optical interface 140. As noted above, the authorization request 1105 can comprise at least one of the following message objects: a protocol version 1110, a cryptosuites list 1115, and a public key 1120 that can be one key of an RSA public-private key pair and is usually referred to as part of the public key certificate. Next, in decision step 1215, it is determined if at least one cryptosuite listed in the authorization request 1105 is acceptable to the laser transceiver node 120. If the inquiry to decision step 1215 is negative, then the “NO” branch is followed to step 1220 in which a cryptosuite failure occurs. Upon any failure of this method, any one of several actions may be taken. In one preferred, yet exemplary embodiment, data exchange without encryption is allowed to continue but only at the lowest possible speed, video broadcast (not the subject of this specification but included in a preferred, exemplary embodiment) is interrupted, and an operator is notified. In other exemplary embodiments, data communications may be disallowed altogether.

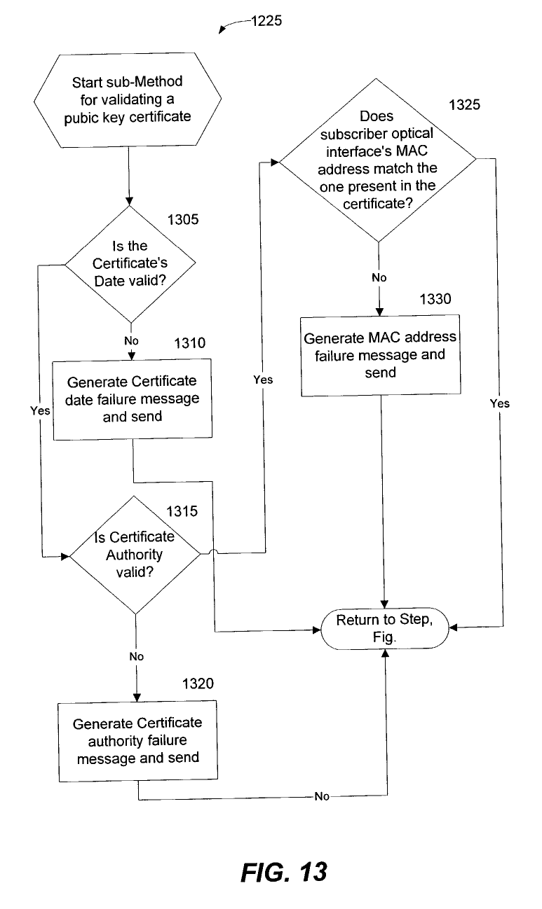

If the inquiry to decision step 1215 is positive, then the “YES” branch is followed to routine 1225 in which it is determined whether the public key 1120 listed in the authorization request 1105 is valid. Further details of routine 1225 will be discussed below with respect to FIG. 13. If the inquiry to decision routine 1225 is negative, then the “NO” branch is followed to step 1230 in which a public key certificate failure occurs. In one preferred, yet exemplary embodiment, data exchange without encryption is allowed to continue but only at the lowest possible speed, video broadcast (not the subject of this specification but included in a preferred, exemplary embodiment) is interrupted, and an operator is notified. In other exemplary embodiments, data communications may be disallowed altogether.

If the inquiry to routine 1225 is positive, then the “YES” branch is followed to step 1235 in which a cryptosuite is selected by the laser transceiver node 120 from the authorization request 1105 in order to encrypt the second message B that is sent to the subscriber optical interface 140.

In step 1240, a first secret parameter such as a large integer governed by equation (1.0) of the Diffie-Hellman key exchange is selected by the laser transceiver node 120. This first secret key parameter is not passed between the parties. In step 1243, the corresponding non-secret key exchange parameter 1135 is computed from the first secret key parameter. The non-secret key exchange parameter is passed between the parties, as described below. Next, in step 1245, the laser transceiver node 120 generates a random number. As noted above, this random number can comprise a random number that is generated from a 256-bit secure hash algorithm (SHA-256).

In step 1250, the laser transceiver node 120 can encrypt its non-secret key exchange parameter 1135 and the random number or nonce 1137 with a public key such as an RSA public-private key corresponding to the public key certificate 1120.

In step 1255, an authorization response message can be sent. In step 1255, the laser transceiver node 140 can generate the authorization response message 1125 that comprises the encrypted non-secret key exchange parameter 1135 and the random number or nonce 1137.

In step 1260, an authorization acknowledge message can be received. In this step, the laser transceiver node can receive the authorization acknowledge message 1145 that is generated by the subscriber optical interface 140. As noted above, the authorization acknowledge message 1145 can comprise the subscriber optical interface's 140 non-secret key exchange parameter 1140 and the nonce 1150, where the nonce 1137 can be encrypted with the shared encryption key. In one exemplary embodiment, the subscriber optical interface's 140 non-secret key exchange parameter 1140 comprises a Diffie-Hellman public key.

In step 1265, the shared encryption key can be generated by the laser transceiver node 120 using equation (1.3) and the first non-secret key parameter 1135 comprising capital letter X of equation (1.0) that is exchanged between the parties and the second secret key parameter small letter y that is not exchanged between the parties. In step 1270, the random number or nonce 1150 can be decrypted with the newly derived shared secret key. In decision step 1275, it is determined if the decrypted received random number or nonce 1150 matches the random number or nonce 1150 that was sent in the second message B.

If the inquiry to decision step 1275 is negative, then the “no” branch is followed to step 1280, in which a secret key failure occurs. In one preferred, yet exemplary embodiment, data exchange without encryption is allowed to continue but only at the lowest possible speed, video broadcast (not the subject of this specification but included in a preferred, exemplary embodiment) is interrupted, and an operator is notified. In other exemplary embodiments, data communications may be disallowed altogether.

If the inquiry to decision step 1275 is positive, and the “yes” branch is followed to step 1285 in which the activation of the shared encryption key and encryption of communication traffic are synchronized by the laser transceiver node 120. In step 1290, communication traffic can start being encrypted with the shared secret key (k=k′), and this communication traffic can be sent to the subscriber optical interface 140 to form a secure communication channel. In other words, the shared encryption key can be used for encryption of communication traffic by becoming the seed used to preload the shift registers 705, 710, and 715 illustrated in FIG. 7.

Referring now to FIG. 13, this figure is a logic flow diagram illustrating an exemplary sub-method 1225 for validating a public key certificate. A first step in the sub-method 1225 is step 1305, in which it is determined whether a certificate's date is valid. If the inquiry to decision step 1405 is negative, then the “no” branch is followed to step 1310 in which a certificate data failure occurs. If the inquiry to decision step 1305 is positive, then the “yes” branch is followed to decision step 1315.

In decision step 1315, it is determined whether the certificate authority that issued the public key certificate is valid. If the inquiry to decision step 1315 is negative, then the “no” branch is followed to step 1320, in which a certificate authority failure occurs. If the inquiry to decision step 1315 is positive, then the “yes” branch is followed to decision step 1325, in which it is determined whether the subscriber optical interface's media access control (MAC) address matches the MAC address present in the public key certificate. If the inquiry to decision step 1325 is negative, then the “no” branch is followed to step 1330, in which the MAC address failure message is generated. If the inquiry to decision step 1325 is positive, then the “yes” branch is followed to step 1335, in which the process returns to step 1235.

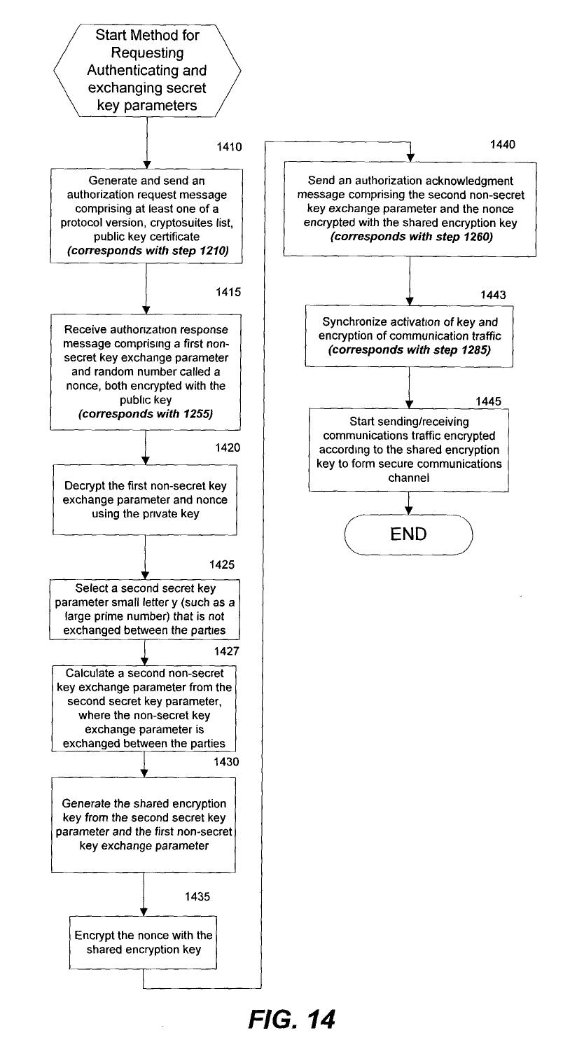

Referring now to FIG. 14, this figure is a logic flow diagram illustrating an exemplary method for authenticating and exchanging shared non-secret key exchange parameters according to an exemplary embodiment of the present invention. This method 1400 describes the steps that can be executed by the subscriber optical interface 140.

Method 1400 starts with step 1410 in which an authentication request message is generated and sent to the laser transceiver node 120. As noted above, an authentication request message 1105 can comprise at least one of a protocol version 1110, a cryptosuites list 1115, and a public key 1120 that can be one key of an RSA public-private key pair and is usually referred to as part of the public key certificate.

In step 1415, an authorization response message 1125 can be received. Step 1415 corresponds to Step 1255 of FIG. 12 in which the laser transceiver node can generate this message in one exemplary embodiment. As noted above, the authorization response message 1125 can comprise an encrypted non-secret key exchange parameter 1135 and an encrypted random number or nonce 1150 where both the key parameter and the random number 1150 are encrypted with the public key corresponding to the public key certificate 1120. In step 1420, the first non-secret key exchange parameter 1125 and the random number or nonce 1150 can be decrypted with a private key that is assigned to the subscriber optical interface 140, usually at its manufacture. The private key can comprise an RSA private key corresponding to the public key of step 1410.

In step 1425, a second secret key parameter (small letter y of equation 1.1) is selected by the subscriber optical interface 140. This secret key parameter is referred to as the second secret key parameter because the laser transceiver node 120 is assigned or selects a first secret key parameter that is also not exchanged between the parties. The second secret key parameter that usually corresponds to small letter y can comprise a large prime number. This second secret key parameter, like the first secret key parameter, is also not passed between the parties. Next, in step 1427, the subscriber optical interface 140 can calculate a second non-secret key exchange parameter 1140 from small letter y. In step 1430, the shared encryption key can be generated from the first non-secret key exchange parameter 1135 and second secret key parameter. Next, in step 1435, the received random number or nonce 1137 can be encrypted with the shared secret key.

In step 1440, an authorization acknowledge message 1145 can be generated and sent to the laser transceiver node 120 where the authorization acknowledge message 1145 can comprise the second non-secret key exchange parameter 1140 and the random number 1150 encrypted by the shared encryption key. In Step 1443, activation of the shared encryption key and encryption of communication traffic is synchronized. In step 1445, communication traffic can be encrypted with the private key and can be sent and received by the subscriber optical interface 140.

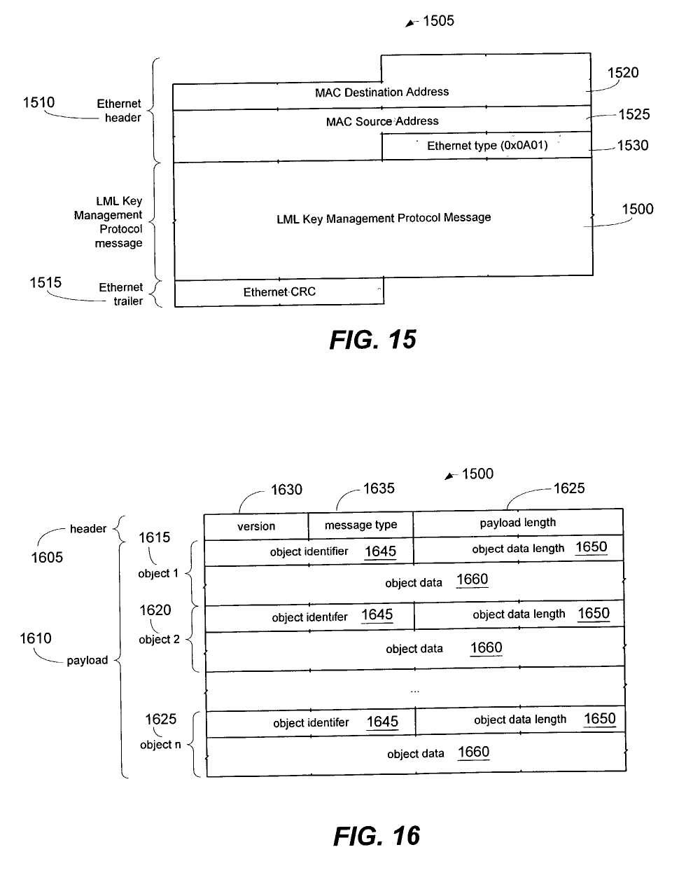

Referring now to FIG. 15, this figure is a diagram that illustrates the relationship between the key management protocol message 1500 and the remaining elements of an Ethernet frame 1505. The key management protocol message 1500 comprises any of the Authorization Request 1105, the Authorization Response 1125 and the Authorization Acknowledge 1145, and can be carried by the Ethernet frame 1505. It can be distinguished by Ethernet type 1530 having a value of 0A01₁₆. In other words, FIG. 15 illustrates the encapsulation of the key management protocol message 1500 by the Ethernet frame 1505.

The Ethernet type value that the key management protocol message 1500 can use may be assigned for the Xerox PARC universal packet (PUP) format if such a format is not to be carried by the system. Alternatively, it could be assigned another Ethernet Type 1530 value, as is understood by those skilled in the art. The Ethernet header 1510 can comprise a media access control (MAC) destination address 1520, a MAC source address 1525, and an Ethernet type 1530. The Ethernet trailer 1515, can comprise an Ethernet cyclic redundancy check (CRC) 1535.

Referring now to FIG. 16, this figure is a functional block diagram illustrating the format for messages that can be exchanged with the present invention. A message 1500 can comprise a header 1605 and a payload 1610. The payload 1610 can comprise a series of individual objects 1615, 1620, and 1625. The first octets or object identifier 1645 can identify the object type. The next two octets or object data length 1650 can comprise the length, in octets, of the object data.

Meanwhile, the header 1605 can solely comprise a version value 1630, a message-type value 1635, and a payload length value 1640. The payload 1610 can comprise one or more objects 1615, 1620, and 1625. Each object 1615, 1620, or 1625 can comprise an object identifier 1645, an object data length value 1650, and object data 1660.

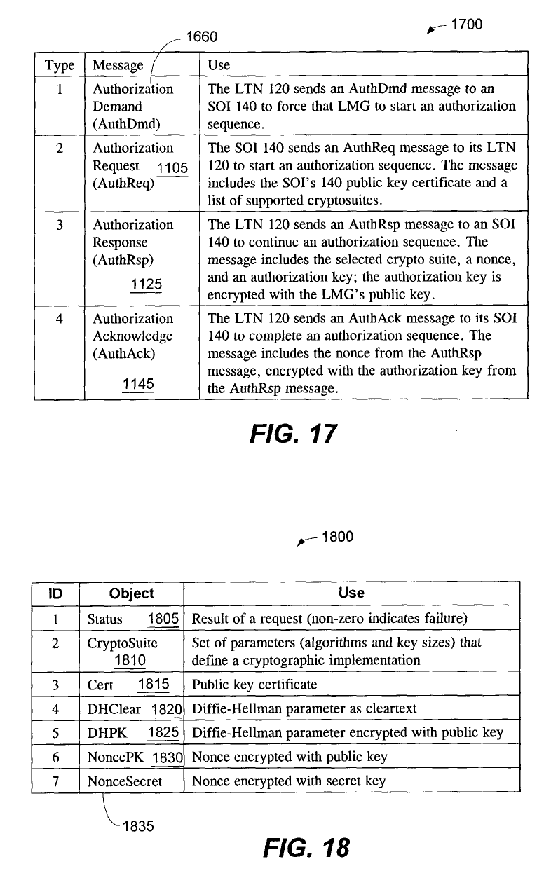

Referring now to FIG. 17, this figure illustrates a table 1700 that describes the different types of messages that can be exchanged between the laser transceiver node 120 and the subscriber optical interface 140 in order to authenticate and exchange a shared key between these two respective parties. The first type of message is the authorization demand message 1705. The authorization demand message 1705 is used when the laser transceiver node 120 wants to initiate communications with a subscriber optical interface 140 before the subscriber optical interface 140 decides to initiate any communications with the laser transceiver node 120. As explained in the “use” column, the laser transceiver node 120 sends an authorization and demand message to the subscriber optical interface to require the subscriber optical interface 140 to start an authorization sequence.

The second type of message is the authorization request message 1105, as discussed above. The subscriber optical interface 140 can send an authorization request message 1105 to the laser transceiver node 120 to start an authorization sequence. The authorization request message, as noted above, with respect to FIG. 11, can comprise the subscriber optical interface's protocol version, it's public key certificate, as well as a list 1115 of supported cryptosuites.

Regarding the third type of message comprising an authorization response message 1125, as noted above, this message can comprise a non-secret key exchange parameter or what is called an authorization key in table 1700. The fourth type of message can comprise the authorization acknowledge message 1145 that includes the second shared non-secret key exchange parameter and the nonce encrypted with the authorization or shared secret key.

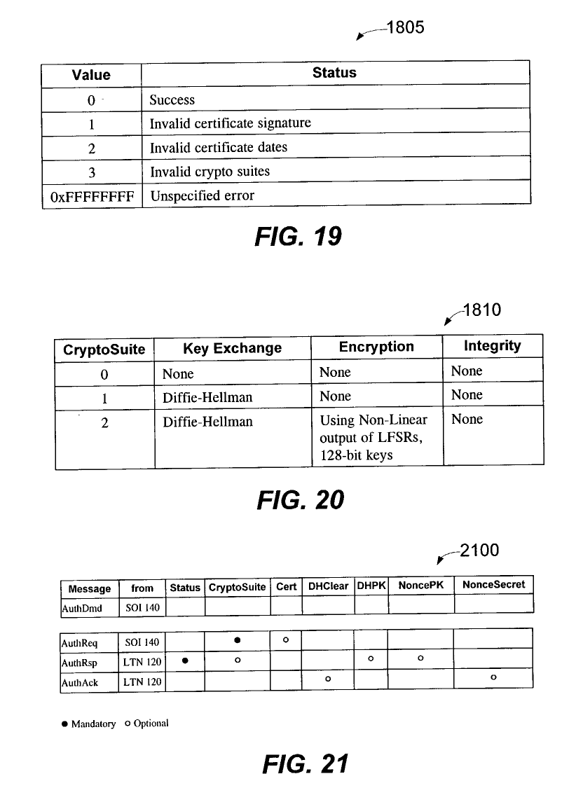

Referring now to FIG. 18, this figure illustrates a table 1800 that describes the various types of objects that can be part of a payload 1610 of a message According to one exemplary embodiment of the present invention. The first type of object can comprise a status object 1805 that can be assigned an identification value of 1. The status object 1805 can comprise four octets of data. Further details of the status object 1805 will be discussed below with respect to FIG. 19. The second type of object can comprise a cryptosuite object 1810 can that be assigned an identification value of 2. Similar to the status object 1805, the cryptosuite object 1810 can comprise four octets of data. Further details of the cryptosuite object 1810 will be described below with respect to FIG. 20.

A third type of object can comprise a certificate object 1815 that comprises the public key certificate 1120. The certificate object 1815 can be assigned an identification value of 3. The certificate object 1815 can comprise a variable length X.509 public key certificate. However, other types of public key certificates are not beyond the scope of the present invention.

Another object can comprise a DHClear object 1820 that comprises a Diffie-Hellman parameter as clear text. The DHClear object 1820 can comprise a Diffie-Hellman key exchange parameter of the form α^{x} mod p, where p is the prime number identified below, α is the generator 2, and x is a secret random number chosen by the sender such that 1≦x≦p−2.

The modulus p is a 2048-bit number equal to 2²⁰⁴⁸−2¹⁹⁸⁴−1+2⁶⁴·└2¹⁹¹⁸·π┘+124476. Its hexadecimal value can comprise the following:

| | | | | | |
|---|---|---|---|---|---|
| FFFFFFFF | FFFFFFFF | C90FDAA2 | 2168C234 | C4C6628B | 80DC1CD1 |
| 29024E08 | 8A67CC74 | 020BBEA6 | 3B139B22 | 514A0879 | 8E3404DD |
| EF9519B3 | CD3A431B | 302B0A6D | F25F1437 | 4FE1356D | 6D51C245 |
| E485B576 | 625E7EC6 | F44C42E9 | A637ED6B | 0BFF5CB6 | F4C6B7ED |
| EE386BFB | 5A899FA5 | AE9F2411 | 7C4B1FE6 | 49286651 | ECE45B3D |
| C2007CB8 | A163BF05 | 98DA4836 | 1C55D39A | 69163FA8 | FD24CF5F |
| 83655D23 | DCA3AD96 | 1C62F356 | 208552BB | 9ED52907 | 7096966D |
| 670C354E | 4ABC9804 | F1746C08 | CA18217C | 32905E46 | 2E36CE3B |
| E39E772C | 180E8603 | 9B2783A2 | EC07A28F | B5C55DF0 | 6F4C52C9 |
| DE2BCBF6 | 95581718 | 3995497C | EA956AE5 | 15D22618 | 98FA0510 |
| 15728E5A | 8AACAA68 | FFFFFFFF | FFFFFEFF. | | |

The DHClear object 1820 can be formatted with its most significant octet first in the packet.

The DHPK object 1825 can comprise a Diffie-Hellman key exchange parameter encrypted by an RSA public key. The DHPK object 1825 can be generated by taking a parameter of the same form as the DHClear object 1820 and encrypting it according to the RSAES-OAEP scheme of version 2.1 of RSA Laboratories' public key cryptography standard #1. The Nonce PK object 1830 can comprise an arbitrary-length random value encrypted by RSA public key. This value 1830 can be encrypted according to RSAES-OAEP scheme of version 2.1 of RSA Laboratories' public key cryptography standard #1. The NonceSecret Object 1835 can comprise an arbitrary-length random value encrypted according to a chosen symmetric encryption algorithm (according to a shared secret key).

Referring now to FIG. 19, this figure illustrates a table 1805 that describes the various values for the status object 1805 that is listed in table 1800. As noted above, the status object 1805 simply comprises four octets of data. The data can represent a single, 32-bit number. A value of 0 typically indicates a successful operation, where other values represent specific error conditions.

Referring now to FIG. 20, this figure illustrates a table 1810 that describes exemplary contents for the cryptosuite message 1810 listed in table 1800. The cryptosuite object 1810 usually comprises four octets of data. The data represents a single, 32-bit number whose value specifies the cryptographic functions, including algorithms and key sizes to be used between the laser transceiver node 120 and the subscriber optical interface 140.

Referring now to FIG. 21, this figure illustrates an exemplary table 2100 that lists different message types, along with their source, and objects that each message type may contain. In one exemplary embodiment, the authorization demand (AuthDmd) message usually comprises no objects. Meanwhile, the authorization request (AuthReq) message usually comprises at least one CryptoSuite object and it may comprise one or more certificate objects. The Authorization Response (AuthRsp) message usually comprises a single Status object. It may also comprise a cryptoSuite object, a DHPK object, and a NoncePK object. And the Authorization Acknowledge Message (AuthAck) message usually comprises a single Status object. It may also comprise a DHClear object and a NonceSecret object.

In summary, the method and system for authenticating parties and exchanging a secret shared key decreases the number of messages exchanged between parties to transfer this information. In other words, the system and method for establishes a secure communication channel over an optical network with a reduced number of messages. Such a reduction in the number of messages exchanged can be beneficial if bandwidth for a particular communications channel is constrained. Also, this reduction provides significant advantages if used to secure a communications channel that has decreased reliability such as in a wireless network. That is, while it is contemplated that the present invention is very suitable for optical networks, it is not beyond the scope of the present invention to employ the methods described herein in a wireless environment. Further, the invention provides a security measure that preserves forward secrecy of any secret encryption keys that are shared between parties.

The present invention has an increased encryption key size that reduces the possibility of a successful attack on a communications channel using the encryption key. The present invention also increases the speed at which a key stream is generated. The present invention generates a key stream that is not derived from shift registers possessing linear relationships between feedback taps. The present invention generates a key stream from feedback taps in a non-linear manner which prevents any attacks on the communication channel when the key stream is used to carry information between parties.

What is claimed is:

1. A method for securing a communications channel having perfect forward secrecy comprising the steps of:
receiving an authorization request message comprising an asymmetric key;
in response to receiving an authorization request message, selecting a symmetric key parameter;
calculating a key exchange parameter based on the symmetric key parameter;
encrypting the key exchange parameter with the symmetric key; and
sending an authorization response message comprising the encrypted asymmetric key exchange parameter.

2. The method of claim 1, further comprising a step of selecting a random number.

3. The method of claim 2, further comprising the step of encrypting the random number with the asymmetric key.

4. The method of claim 1, wherein the symmetric key is part of a public-key algorithm.

5. The method of claim 1, wherein the symmetric key is part of an RSA public-key certificate.

6. The method of claim 1, wherein the symmetric key parameter is part of a Diffie-Hellman key exchange protocol.

7. A method for securing a communications channel having perfect forward secrecy comprising the steps of:
receiving an authorization response message comprising an encrypted first asymmetric key exchange parameter;
in response to receiving the authorization response message, decrypting the encrypted asymmetric key exchange parameter;
selecting a secret key parameter; and
calculating a second asymmetric key exchange parameter based on the secret key parameter; and
calculating a shared asymmetric encryption key based on the secret key parameter and the first asymmetric key exchange parameter.

8. The method of claim 7, wherein the step of receiving an authorization response message further comprises receiving an authorization response message comprising an encrypted random number.

9. The method of claim 8, further comprising the step of decrypting the encrypted random number with an asymmetric key.

10. The method of claim 7, further comprising the step of encrypting a random number with the shared asymmetric encryption key.

11. The method of claim 7, further comprising the step of sending an authorization acknowledgment message comprising the second asymmetric key exchange parameter.

12. The method of claim 7, further comprising the step of sending communications traffic encrypted with the shared asymmetric encryption key.

13. A method for generating non-linear ciphertext derived from a linear source comprising the steps of:
selecting a first tap and a second tap in a register;
combining an output of the first tap with an output of the second tap;
calculating a first value from a logical “and” operation taken between the outputs of the first and second taps;
selecting a third output bit of the register;
combining the first value with the third output bit of the register;
calculating a second value from an exclusive “or” operation taken between the first value and the least significant output bit of the register; and
forming ciphertext derived from plain text and the second value.

14. The method of claim 13, further comprising the step of calculating a plurality of second values with a plurality of registers.

15. The method of claim 14, further comprising the steps of:
combining the plurality of second values together;
calculating a third value from an exclusive “or” operation taken between the combined second values.

16. The method of claim 15, further comprising the step of calculating a plurality of third values from a plurality of sets of registers.

17. The method of claim 19, wherein the step of forming cipher text further comprises the step of combining plain text with the plurality of third values.

18. The method of claim 17, further comprising the step of determining whether a clock tap of a register matches a majority clock value.

19. A laser transceiver node comprising:
an optical tap routing device for apportioning the bandwidth between subscribers of an optical network system, the optical tap routing device further operable for:
selecting a symmetric key parameter;
calculating a key exchange parameter based on the symmetric key parameter;
encrypting the key exchange parameter with the symmetric key;
a tap multiplexer coupled to the optical tap routing device for multiplexing upstream and downstream signals.

20. The laser transceiver node of claim 19, further comprising a laser optical transmitter coupled to the tap multiplexer for generating optical signals.

21. The laser transceiver node of claim 19, further comprising a laser optical receiver coupled to the tap multiplexer for converting optical signals into electrical signals.

22. The laser transceiver node of claim 19, wherein the optical tap routing device further comprises a plurality of registers for generating ciphertext.

23. The laser transceiver node of claim 22, wherein the registers employ non-linear filtering to produce the ciphertext.

24. A subscriber optical interface comprising:
a processor for controlling the digital optical transmitter and receiver, the processor further operable for:
receiving a message comprising an encrypted first asymmetric key exchange parameter;
in response to receiving the message, decrypting the encrypted asymmetric key exchange parameter;
selecting a secret key parameter; and
calculating a second asymmetric key exchange parameter based on the secret key parameter.

25. The subscriber optical interface of claim 24, wherein the processor is further operable for calculating a shared asymmetric encryption key based on the secret key parameter and the first asymmetric key exchange parameter.

26. The subscriber optical interface of claim 24, further comprising:
a bidirectional optical signal splitter;
a digital optical receiver coupled to the splitter; and
a digital optical transmitter coupled to the splitter.

27. The subscriber optical interface of claim 24, wherein the processor further comprises a plurality of registers for generating ciphertext.

28. The subscriber optical interface of claim 27, wherein the registers employ non-linear filtering to produce the ciphertext.

29. A system for securing communications channels, comprising:
a register comprising;
a first tap and a second tap for calculating a first value taken between the outputs of the first and second taps, the output between the first tap and second tap comprising a non-linear value;
an output of the register taken between the first value and a third output bit of the register; and
a new bit comprising an operation taken between the taps of the register.

30. The system of claim 29, wherein the register further comprises a tap coupled to a majority clock function, wherein the register is clocked when the tap coupled to the majority clock function equals a majority value of the majority clock function.

31. The system of claim 29, wherein the system comprises a plurality of registers designated as a set and for producing at least one bit of a keystream.

32. The system of claim 29, wherein the system comprises a plurality of sets of registers, and wherein output of each set is combined to form a keystream.

33. The system of claim 32, wherein the keystream is combined with plain text to form ciphertext.

34. The system of claim 32, wherein the keystream is combined with plain text in an exclusive “or” operation to form ciphertext.

35. The system of claim 29, wherein the register comprises a Linear Feedback Shifter Register (LFSR).
